(19) United States
(12) Patent Application Publication
(10) Pub. No.: US 2014/0150980 A1
(43) Pub. Date: Jun. 5, 2014

(54) PEELING APPARATUS, PEELING SYSTEM AND PEELING METHOD

(71) Applicant: Tokyo Electron Limited, Tokyo (JP)

(72) Inventors: Masanori Itou, Kumamoto (JP); Masaru Honda, Kumamoto (JP); Takayuki Chinju, Kumamoto (JP)

(73) Assignee: Tokyo Electron Limited, Tokyo (JP)

(21) Appl. No.: 14/083,721

(22) Filed: Nov. 19, 2013

(30) Foreign Application Priority Data
Dec. 4, 2012 (JP) 2012-265401

(51) Int. Cl. B32B 43/00

(52) U.S. Cl. CPC B32B 43/006
USPC 156/714; 156/761

(57) ABSTRACT

Provided is a peeling apparatus including a first holding unit, a second holding unit, and a peeling inducing unit. The first holding unit holds a first substrate of a superimposed substrate in which the first substrate and a second substrate are bonded. The second holding unit holds the second substrate of the superimposed substrate and moves the second substrate in a direction of separating the second substrate from a surface of the first substrate. The peeling inducing unit forms an area where the second substrate starts to be peeled off from the first substrate on a side surface of the superimposed substrate. The peeling inducing unit includes a sharp member, and a moving mechanism that moves the sharp member toward a side surface portion of the second substrate adjacent to a bonding portion of the first substrate and the second substrate in the side surface of the superimposed substrate.

### CROSS-REFERENCE TO RELATED APPLICATIONS

This application is based on and claims priority from Japanese Patent Application No. 2012-265401 filed on Dec. 4, 2012 with the Japan Patent Office and the disclosure of which is incorporated herein in its entirety by reference.

### TECHNICAL FIELD

The present disclosure relates to a peeling apparatus, a peeling system and a peeling method.

### BACKGROUND

Semiconductor wafers such as, for example, silicon wafers or compound wafers, have recently got larger in diameter and thinner in thickness in semiconductor device manufacturing processes, for example. When a semiconductor substrate has a large diameter and a thin thickness, warpage or crack may occur in the semiconductor substrate during conveyance or a polishing process. For this reason, the conveyance or the polishing process is performed after a support substrate is bonded to the semiconductor substrate to reinforce the semiconductor substrate. After the conveyance or the polishing process, the support substrate is peeled off from the semiconductor substrate.

For example, Japanese Patent Laid-Open Publication No. 2012-69914 discloses a peeling technology in which a semiconductor substrate is held using a first holding unit, a support substrate is held using a second holding unit, and the circumferential edge of the second holding unit is moved in the vertical direction so as to peel off the support substrate from the semiconductor substrate.

### SUMMARY

A peeling apparatus according to an aspect of the present disclosure includes a first holding unit, a second holding unit, and a peeling inducing unit. The first holding unit is configured to hold a first substrate in a superimposed substrate in which the first substrate and a second substrate are bonded to each other. The second holding unit is configured to hold the second substrate in the superimposed substrate and move the second substrate in a direction of separating the second substrate from a surface of the first substrate. The peeling inducing unit is configured to form a peeling initiation area where the second substrate starts to be peeled off from the first substrate on a side surface of the superimposed substrate. In addition, the peeling inducing unit includes a sharp member and a moving mechanism configured to move the sharp member toward a side surface portion of the second substrate adjacent to a bonding portion between the first and second substrates in the side surface of the superimposed substrate.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a schematic plan view illustrating a configuration of a peeling system according to a first exemplary embodiment.

FIG. 2 is a schematic side view illustrating a superimposed substrate held in a dicing frame.

FIG. 3 is a schematic plan view illustrating the superimposed substrate held in the dicing frame.

FIG. 4 is a flowchart illustrating a substrate processing sequence executed by a peeling system.

FIG. 5A is a schematic view illustrating conveyance routes of a superimposed substrate.

FIG. 5B is a schematic view illustrating conveyance routes of a substrate to be processed and a support substrate.

FIG. 6 is a schematic side view illustrating a configuration of a peeling apparatus according to the first exemplary embodiment.

FIG. 7 is a schematic side view illustrating a sharp member.

FIG. 8A is an explanatory view illustrating an operation in a peeling inducing processing.

FIG. 8B is an explanatory view illustrating another operation in the peeling inducing processing.

FIG. 8C is an explanatory view illustrating still another operation in the peeling inducing processing.

FIG. 9A is a schematic plan view illustrating a suction pad provided in a first suction and moving unit and a suction pad provided in a second suction and moving unit.

FIG. 9B is a schematic enlarged view illustrating the suction pad provided in the first suction and moving unit.

FIG. 10 is a flowchart illustrating a peeling processing sequence.

FIG. 11A is an explanatory view illustrating a peeling operation by a peeling apparatus.

FIG. 11B is an explanatory view illustrating another peeling operation by the peeling apparatus.

FIG. 11C is an explanatory view illustrating another peeling operation by the peeling apparatus.

FIG. 11D is an explanatory view illustrating still another peeling operation by the peeling apparatus.

FIG. 11E is an explanatory view illustrating yet another peeling operation by the peeling apparatus.

FIG. 12A is a schematic view illustrating a configuration of a first cleaning apparatus.

FIG. 12B is a schematic side view illustrating a substrate holding unit and a cleaning jig in the first cleaning apparatus.

FIG. 12C is a schematic plan view illustrating the configuration of the cleaning jig.

FIG. 13 is a schematic side view illustrating a configuration of a third conveyance apparatus.

FIG. 14A is a schematic side view illustrating a configuration of a second cleaning apparatus.

FIG. 14B is a schematic plan view illustrating the configuration of the second cleaning apparatus.

FIG. 15A is a schematic plan view illustrating a modified example of the second holding unit.

FIG. 15B is a schematic plan view illustrating another modified example of the second holding unit.

FIG. 16 is a schematic side view illustrating a configuration of a peeling apparatus according to a second exemplary embodiment.

FIG. 17A is a schematic perspective view illustrating a configuration of a second holding unit of the peeling apparatus according to the second exemplary embodiment.

FIG. 17B is a schematic plan view illustrating a configuration of a suction pad.

FIG. 18 is a view illustrating an example of a measurement processing operation by a measurement unit.

FIG. 19A is a schematic view illustrating an SOI substrate manufacturing process.

FIG. 19B is a schematic view illustrating another SOI substrate manufacturing process.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made without departing from the spirit or scope of the subject matter presented here.

In the related art as described above, there is room for further improvement in view of promoting the efficiency of a peeling processing. Such a problem may also occur in a process of manufacturing, for example, an SOI (Silicon On Insulator) which involves peeling of a substrate.

The present disclosure is to provide a peeling apparatus, a peeling system and a peeling method which may promote the efficiency of a peeling processing.

A peeling apparatus according to an aspect includes a first holding unit, a second holding unit, and a peeling inducing unit. The first holding unit is configured to hold a first substrate in a superimposed substrate in which the first substrate and a second substrate are bonded. The second holding unit is configured to hold the second substrate in the superimposed substrate and move the second substrate in a direction of separating the second substrate from a surface of the first substrate. The peeling inducing unit is configured to form an area where the second substrate starts to be peeled off from the first substrate on a side surface of the superimposed substrate. In addition, the peeling inducing unit includes a sharp member, and a moving mechanism configured to move the sharp member toward a side surface portion of the second substrate adjacent to a bonding portion of the first substrate and the second substrate in the side surface of the superimposed substrate.

In the peeling apparatus as described above, the moving mechanism moves the sharp member further forward after the sharp member comes into contact with the side surface portion of the second substrate adjacent to the bonding portion.

The peeling apparatus as described above may further include a first holding unit moving mechanism configured to move the first holding unit in a direction of separating the first substrate from the second substrate. The moving mechanism moves the sharp member further forward while the first holding unit moving mechanism moves the first holding unit.

In the peeling apparatus as described above, the sharp member is formed of a hard metal.

In the peeling apparatus as described above, the second holding unit includes: a first suction and moving unit configured to suck a circumferential edge of the second substrate corresponding to the area and move the circumferential edge in a direction of separating the circumferential edge from a surface of the first substrate; and a second suction and moving unit configured to suck a region which is closer to a central portion of the second substrate than to the circumferential edge and move the region in a direction of separating the region from the surface of the first substrate.

In the peeling apparatus as described above, the first suction and moving unit has a suction area which is smaller than that of the second suction and moving unit.

In the peeling apparatus, the second suction and moving unit moves the region which is closer to the central portion of the second substrate than to the circumferential edge in the direction of separating the region from the surface of the first after the first suction and moving unit moves the circumferential edge of the second substrate in the direction of separating the circumferential edge from the surface of the first substrate.

In the peeling apparatus as described above, the second suction and moving unit sucks the central portion of the second substrate.

In the peeling apparatus as described above, the first suction and moving unit has a portion corresponding to an outer edge of the second substrate and formed in an arc shape along the outer edge of the second substrate.

The peeling apparatus as described above may further include: a measurement unit configured to measure a distance from a predetermined measurement reference position to a holding surface of the first holding unit or a distance from the measurement reference position to an object interposed between the measurement reference position and the holding surface; and a positioning unit configured to adjust a contact position of the sharp member in relation to the second substrate based on a measurement result of the measurement unit and information relating to a thickness of the superimposed substrate and acquired in advance.

The peeling apparatus as described above may further include a rotation mechanism configured to rotate the first holding unit.

A peeling system according to another aspect includes: a carry-in/out station configured to dispose a superimposed substrate in which a first substrate and a second substrate are bonded; a substrate conveyance apparatus configured to convey the superimposed substrate disposed in the carry-in/out station; and a peeling station configured to separate the superimposed substrate conveyed by the substrate conveyance apparatus into the first substrate and the second substrate. The peeling apparatus includes: a first holding unit configured to hold a first substrate of the superimposed substrate; a second holding unit configured to hold the second substrate of the superimposed substrate and move the second substrate in a direction of separating the second substrate from a surface of the first substrate; and a peeling inducing unit configured to form an area where the second substrate starts to be peeled off from the first substrate on a side surface of the superimposed substrate. The peeling inducing unit includes: a sharp member; and a moving mechanism configured to move the sharp member toward a side surface portion of the second substrate adjacent to a bonding portion of the first substrate and the second substrate in the side surface of the superimposed substrate.

A peeling method according to another aspect includes: holding, by a first holding unit, a first substrate of a superimposed substrate in which the first substrate and a second substrate are bonded, the first holding unit being configured to hold the first substrate; holding, by a second holding unit, the second substrate of the superimposed substrate and moving the second substrate in a direction of separating the second substrate from a surface of the first substrate, the second holding unit being configured to hold and move the second substrate in the direction of separating the second substrate from the surface of the first substrate; and forming, by a peeling inducing unit, an area where the second substrate starts to be peeled off from the first substrate on a side surface of the superimposed substrate by causing a sharp member of the peeling inducing unit to come into contact with a side surface portion of the second substrate adjacent to the bonding portion, thereby inducing peeling. The peeling inducing unit includes the sharp member, and a moving mechanism configured to move the sharp member toward a side surface portion of the second substrate adjacent to a bonding portion of the first substrate and the second substrate in the side surface of the superimposed substrate.

In the peeling method as described above, the inducing of peeling includes moving the sharp member further forward by the moving mechanism after the sharp member comes into contact with the side surface portion of the second substrate adjacent to the bonding portion.

In the peeling method as described above, the inducing of peeling includes moving the sharp member further forward by the moving mechanism while the first holding unit is moved by a first holding unit moving mechanism configured to move the first holding unit in a direction of separating the first substrate from the second substrate.

According to the aspects as described above, the efficiency of a peeling processing may be promoted.

Hereinafter, exemplary embodiments of a peeling apparatus, a peeling system and a peeling method disclosed herein will be described in detail with reference to the accompanying drawings. However, the present disclosure is not limited by the exemplary embodiments illustrated below.

### First Exemplary Embodiment

<1. Peeling System>

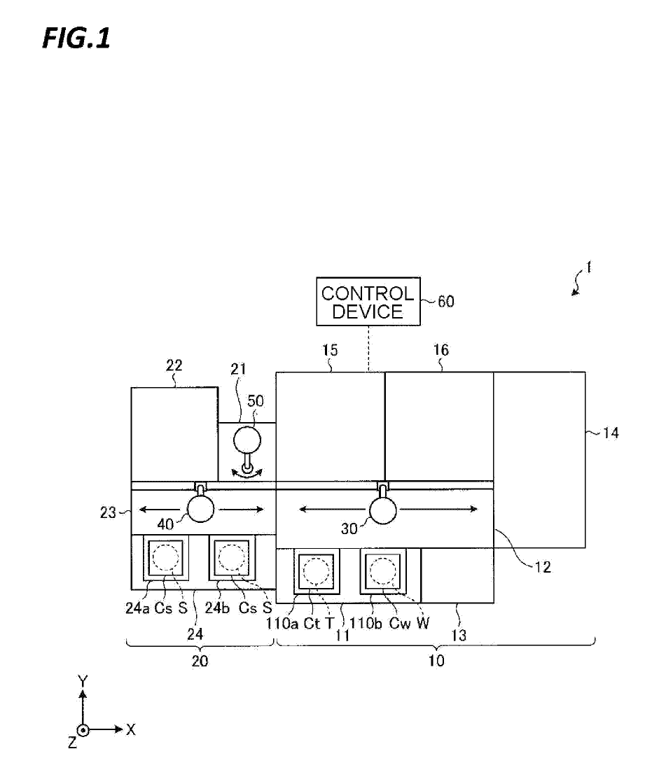

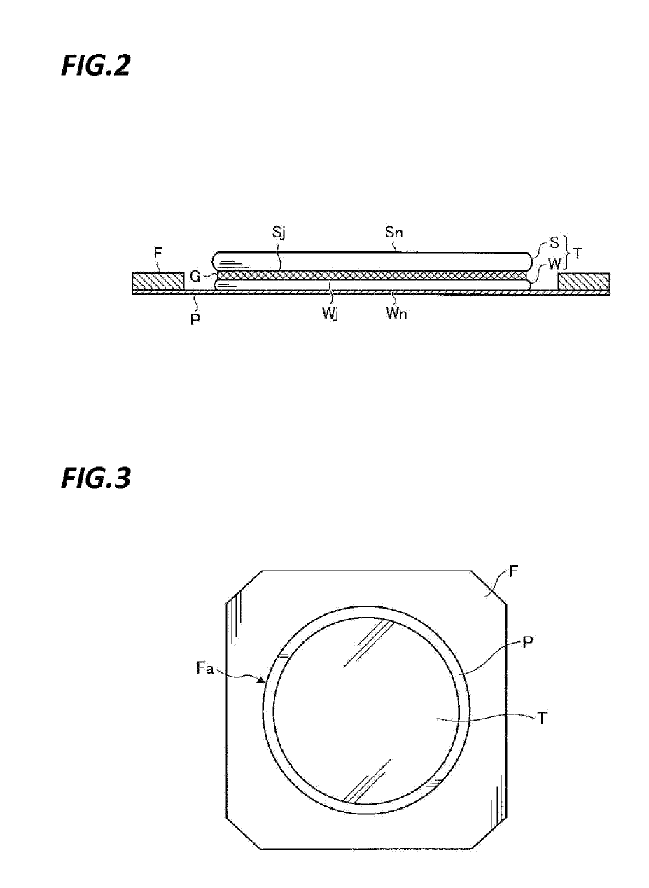

First, a configuration of a peeling system according to a first exemplary embodiment will be described with reference to FIGS. 1 to 3. FIG. 1 is a schematic plan view illustrating a configuration of a peeling system according to the first exemplary embodiment. FIGS. 2 and 3 are a schematic side view and a plan view illustrating a superimposed substrate held in a dicing frame. Hereinafter, in order to clarify a positional relationship, an X-axis direction, a Y-axis direction and a Z-axis direction which lie at right angles to each other will be defined and the Z-axis direction will be assumed as the vertically upward direction.

The peeling system 1 according to the first exemplary embodiment illustrated in FIG. 1 separates a superimposed substrate T in which a substrate to be processed W and a support substrate S are bonded to each other by glue G (see, e.g., FIG. 2) into the substrate to be processed W and the support substrate S.

Hereinafter, of the surfaces of the substrate to be processed W, the surface at the side bonded with the support substrate S through the glue G will be referred to as a “bonding surface Wj” and the surface opposite to the bonding surface Wj will be referred to as a “non-bonding surface Wn”, as illustrated in FIG. 2. In addition, of the surfaces of the support substrate S, the surface at the side bonded with the substrate to be processed W through the glue G will be referred to as a “bonding surface Sj” and the surface opposite to the boding surface Sj will be referred to as a “non-bonding surface Sn”.

The substrate to be processed W is a substrate which is formed with a plurality of electronic circuits on a semiconductor substrate such as, for example, a silicon wafer or a compound semiconductor wafer and the surface where the electronic circuits are formed corresponds to the bonding surface Wj. In addition, the substrate to be processed W is thinned in thickness since, for example, the non-bonding surface Wn has been subjected to a polishing processing. Specifically, the thickness of the substrate to be processed W is about 20 μm to 200 μm.

Meanwhile, the support substrate S has a diameter which is substantially the same as that of the substrate to be processed W and supports the substrate to be processed W. The thickness of the support substrate S is about 650 μm to 750 μm. As for the support substrate S, for example, a glass wafer may be used besides the silicon wafer. The thickness of the glue G that bonds the substrate to be processed W and the support substrate S is about 40 μm to 150 μm.

As described above, the substrate to be processed W is very thin and apt to be fractured. Therefore, the substrate to be processed W is additionally protected by a dicing frame F. As illustrated in FIG. 3, the dicing frame F is a substantially rectangular member having an opening Fa at the central portion thereof. The diameter of the opening Fa is larger than that of the superimposed substrate T. The dicing frame F is formed of a metal such as, for example, a stainless steel.

The superimposed substrate T is disposed in the opening Fa of the dicing frame F and a dicing tape P is adhered to the non-bonding surface Wn of the substrate to be processed W and the dicing frame F to blocks the opening Fa at the rear side. As a result, the superimposed substrate T is held in the dicing frame F. Specifically, the superimposed substrate T is held in the dicing frame F a state where the substrate to be processed W is positioned on the bottom surface and the support substrate S is positioned on the top surface (see, e.g., FIG. 2).

As illustrated in FIG. 1, the peeling system 1 is provided with a first processing block 10 and a second processing block 20. The first processing block 10 and the second processing block 20 are arranged side by side in the X-direction in the order of the second processing block 20 and the first processing block 10.

The first processing block 10 is configured to perform a processing in relation to a substrate held by the dicing frame F, specifically, the superimposed substrate T or the substrate to be processed W after peeling-off. The first processing block 10 is provided with a carry-in/out station 11, a first conveyance region 12, a standby station 13, an edge cut station 14, a peeling station 15, and a first cleaning station 16.

In addition, the second processing block 20 is configured to perform a processing in relation to a substrate which is not held by the dicing frame F, specifically, the support substrate S after peeling-off. The second processing block 20 is provided with a transfer station 21, a second cleaning station 22, a second conveyance region 23, and a carry-out station 24.

The first conveyance region 12 of the first processing block 10 and the second conveyance region 23 of the second processing block 20 are arranged side by side in the X-axis direction. In addition, at the negative side of the Y-axis of the first conveyance region 12, the carry-in/out station 11 and the standby station 13 are arranged side by side in the X-axis direction in the order of the carry-in/out station 11 and the standby station 13, and the carry-out station 24 is arranged at the negative side of the Y-axis of the second conveyance region 23.

In addition, the peeling station 15 and the first cleaning station 16 are arranged side by side in the X-axis direction at the opposite side to the carry-in/out station 11 and the standby station 13 with the first conveyance region 12 being interposed therebetween, in the order of the peeling station 15 and the first cleaning station 16. Further, the transfer station 21 and the second cleaning station 22 are arranged side by side in the X-axis direction at the opposite side to the carry-out station 24 with the second conveyance region 23 being interposed therebetween, in the order of the second cleaning station 22 and the transfer station 21. In addition, the edge cut station 14 is disposed at the positive side of the X-axis direction of the first conveyance region 12.

First, descriptions will be made on the configuration of the first processing block 10. A cassette Ct which accommodates a superimposed substrate T held in the dicing frame F and a cassette Cw which accommodates a substrate to be processed W after being feeling off are carried in/out between the carry-in/out station 11 and the outside. A cassette mounting stand is installed in the carry-in/out station 11 and the cassette mounting stand is provided with a plurality of cassette mounting plates 110a, 110b on which the cassettes Ct, Cw are mounted, respectively.

In the first conveyance region 12, the conveyance of the superimposed substrate T of the substrate to be processed W after peeling-off is performed. The first conveyance region 12 is provided with a first conveyance apparatus 30 which performs the conveyance of the superimposed substrate T or the substrate to be processed W after peeling-off.

The first conveyance apparatus 30 is a substrate conveyance apparatus that includes a conveyance arm unit configured to be capable of moving in the horizontal direction, lifting in the vertical direction, and turning about the vertical direction, and a substrate holding unit attached to a front end of the conveyance arm unit. The first conveyance apparatus 30 is configured to hold a substrate using the substrate holding unit and to convey the substrate held by the substrate holding unit to a desired place using the conveyance arm unit.

In addition, the substrate holding unit provided in the first conveyance apparatus 30 is configured to hold the dicing frame F by, for example, suction or gripping, so that the superimposed substrate T or the substrate to be processed W after peeling-off may be held substantially horizontally.

In the standby station 13, an identification (“ID”) reading device configured to read the ID of the dicing frame F is disposed so that the superimposed substrate T under a processing may be identified by the ID reading device.

In the standby station 13, a standby processing of temporarily putting the superimposed substrate T which is ready to be processed on standby is performed as desired, in addition to the ID reading processing. The standby station 13 is provided with a mounting stand on which the superimposed substrate T conveyed by the first conveyance apparatus 30 is mounted, and the mounting stand is mounted with the ID reading device and a temporary standby unit.

In the edge cut station 14, an edge cut processing is performed to remove the circumferential edge portion of the glue G (see, e.g., FIG. 2) by solving the circumferential edge portion by a solvent. When the circumferential edge portion of the glue G is removed by the edge cut processing, the substrate to be processed W and the support substrate S may be easily peeled off in a peeling processing which will be described later. The edge cut station 14 is provided with an edge cut apparatus which is configured to solve the circumferential edge of the guide G by immersing the superimposed substrate T into the solvent of the glue G.

In the peeling station 15, a peeling processing is performed to separate the superimposed substrate T conveyed by the first conveyance apparatus 30 into the substrate to be processed W and the support substrate S. The peeling station 15 is provided with a peeling apparatus configured to perform the peeling processing. The detailed configuration and operations of the peeling apparatus will be described later.

In the first cleaning station 16, a cleaning processing of the substrate to be processed W after peeling-off is performed. The first cleaning station 16 is provided with a first cleaning apparatus configured to clean the substrate to be processed W after peeling-off in a state where the substrate to be processed W is held in the dicing frame F. The detailed configuration of the first cleaning apparatus will be described later.

In the first processing block 10, the ID reading processing of the dicing frame F is performed in the standby station 13, the edge cut processing of the superimposed substrate T is performed in the edge cut station 14, and then, the peeling processing of the superimposed substrate T is performed in the peeling station 15. In addition, in the first processing block 10, the substrate to be processed W after peeling-off is cleaned in the first cleaning station 16, and the substrate to be processed W after cleaning is conveyed to the carry-in/out station 11. Then, the substrate to be processed W after cleaning is carried out to the outside from the carry-in/out station 11.

Subsequently, the configuration of the second processing block 20 will be described. In the transfer station 21, a transfer processing is performed to receive the support substrate S after peeling-off from the peeling station 15 and to transfer the support substrate S after peeling-off to the second cleaning station 22. The transfer station 21 is provided with a third conveyance apparatus 50 configured to hold the support substrate S after peeling-off in a contactless manner, and the transfer processing is performed by the third conveyance apparatus 50. The detailed configuration of the third conveyance apparatus 50 will be described later.

In the second cleaning station 22, a second cleaning processing is performed to clean the support substrate S after peeling-off. The second cleaning station 22 is provided with a second cleaning apparatus configured to clean the support substrate S after peeling-off. The detailed configuration of the second cleaning apparatus will be described later.

In the second conveyance region 23, the conveyance of the support substrate S cleaned by the second cleaning apparatus is performed. The second conveyance region 23 is provided with a second conveyance apparatus 40 configured to convey the support substrate S.

The second conveyance apparatus 40 is a substrate conveyance apparatus that includes a conveyance arm unit configured to be capable of moving in the horizontal direction, lifting in the vertical direction, and turning about the vertical, and a substrate holding unit attached to the front end of the conveyance arm unit. The second conveyance apparatus 40 is configured to hold a substrate using a substrate holding unit and to convey the substrate held by the substrate holding unit to the carry-out station 24 by the conveyance arm unit. In addition, the substrate holding unit provided in the second conveyance apparatus 40 is, for example, a fork configured to support the support substrate S from the lower side so that the support substrate S may be held substantially horizontally.

The cassette Cs that accommodates the support substrate S is carried in/out between the carry-out station 24 and the outside. The carry-out station 24 is provided with a cassette mounting stand and the cassette is provided with a plurality of cassette mounting plates 24a, 24b on which the cassette Cs is mounted.

In the second processing block 20, the support substrate S after peeling-off is conveyed from the peeling station 15 to the second cleaning station 22 through the transfer station 21 and cleaned in the second cleaning station 22. Thereafter, in the second processing block 20, the support substrate S after peeling-off is conveyed to the carry-out station 24 and the support substrate S after peeling-off is conveyed to the outside from the carry-out station 24.

In addition, the peeling system 1 is provided with a control device 60. The control device 60 is configured to control the operations of the peeling system 1. The control device 60 is, for example, a computer, and is provided with a control unit and a storage unit which are not illustrated. The storage unit stores a program that controls various processings such as, for example, the peeling processing. The control unit controls the operations of the peeling system 1 by reading and executing the program stored in the storage unit.

Further, the program may be a program that has been stored in a computer-readable recording medium and is installed in the storage unit of the control device 60 from the recording medium. As for the recording medium, for example, a hard disc (HD), a flexible disc (FD), a compact disc (CD), a magnet optical disc (MO), or a memory card, may be used.

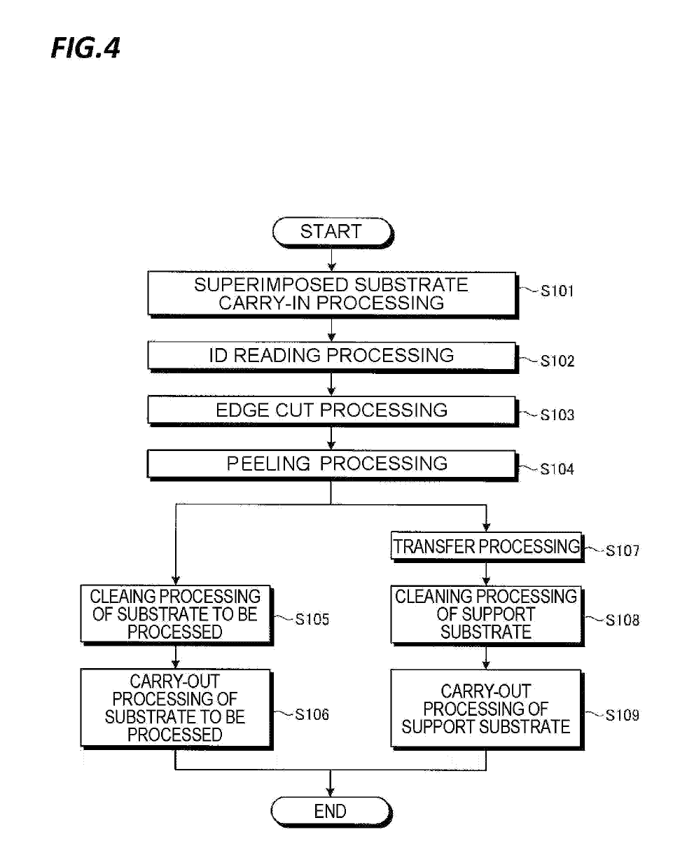

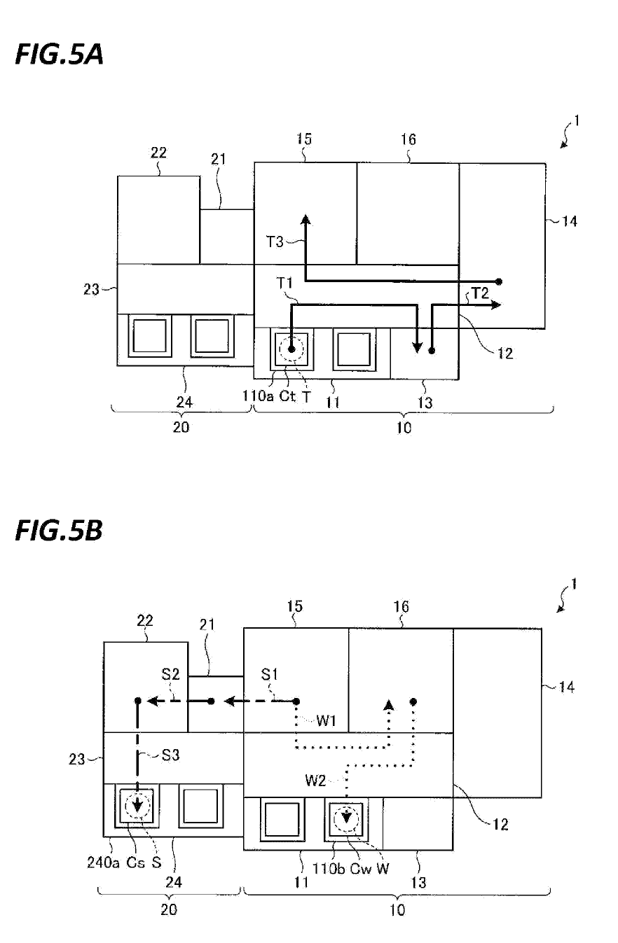

Next, the operations of the peeling system 1 as described above will be described with reference to FIGS. 4, 5A and 5B. FIG. 4 is a flowchart illustrating a substrate processing sequence executed by the peeling system 1. FIG. 5A is a schematic view illustrating conveyance routes of the superimposed substrate T, FIG. 5B is a schematic view illustrating conveyance routes of the substrate to be processed W and the support substrate S. In addition, the peeling system 1 executes respective processing sequences illustrated in FIG. 4 based on a control of the control device 60.

First, the first conveyance apparatus 30 (see, e.g., FIG. 1) disposed in the first conveyance region 12 of the first processing block 10 performs a processing of carrying the superimposed substrate T into the standby station 13 based on the control of the control device 60 (step S101 of FIG. 4) (see, e.g., T1 of FIG. 5A).

Specifically, the first conveyance apparatus 30 introduces the substrate holding unit into the carry-in/out station 11 and holds the superimposed substrate T accommodated in the cassette Ct to take out the superimposed substrate T from the cassette Ct. In that event, the superimposed substrate T is held on the substrate holding unit of the first conveyance apparatus 30 from the upper side in a state where the substrate to be processed W is positioned at the bottom side and the support substrate S is positioned at the top side. In addition, the first conveyance apparatus 30 carries the superimposed substrate T taken out from the cassette Ct into the standby station 13.

Subsequently, in the standby station 13, the ID reading device performs the ID reading processing based on the control of the control device 60 to read the ID of the dicing frame F (step S102 in FIG. 4). The ID read by the ID reading device is transmitted to the control device 60.

Subsequently, the first conveyance apparatus 30 carries out the superimposed substrate T from the standby station 13 and convey the superimposed substrate T to the edge cut station 14 based on the control of the control device 60 (see, e.g., T2 in FIG. 5A). In addition, in the edge cut station 14, the edge cut apparatus performs an edge cut processing based on the control of the control device 60 (step S103 of FIG. 4). With the edge cut processing, the circumferential edge of the glue G is removed so that the substrate to be processed W and the support substrate S may be easily peeled off in the subsequent peeling processing. As a result, a time required for the peeling processing may be shortened.

In the peeling system 1 according to the first exemplary embodiment, since the edge cut station 14 is incorporated in the first processing block 10, the superimposed substrate T carried into the first processing block 10 may be directly carried into the edge cut station 14 using the first conveyance apparatus 30. Therefore, with the peeling system 1, the throughput of a series of substrate processings may be enhanced. In addition, a time period from the edge cut processing to the peeling processing may be easily managed and the peeling performance may be stabilized. The peeling system 1 does not have to include the edge cut station 14.

In addition, when a superimposed substrate T which is standing by a processing occurs, for example, due to a difference in processing time between apparatuses, the superimposed substrate T may be temporarily put in standby using the temporary standby unit provided in the standby station 13. Therefore, a time loss between a series processes may be shortened.

Subsequently, the first conveyance apparatus 30 carries out the superimposed substrate T after edge cutting from the edge cut station 14 and carries the superimposed substrate T into the peeling station 15 based on the control of the control device 60 (see, e.g., T3 in FIG. 5A). In addition, in the peeling station 15, the peeling apparatus performs the peeling processing based on the control of the control device 60 (step S104 in FIG. 4).

Thereafter, in the peeling system 1, a processing related to the substrate to be processed W after peeling-off is performed in the first processing block 10 and a processing related to the support substrate S after peeling-off is performed in the second processing block 20. Further, the substrate to be processed W after peeling-off is held by the dicing frame F.

First, in the first processing block 10, the first conveyance apparatus 30 carries out the substrate to be processed W after peeling-off from the peeling apparatus and conveys the substrate to be processed W to the first cleaning station 16 based on the control of the control device 60 (see, e.g., W1 in FIG. 5B).

In addition, the first cleaning apparatus performs a cleaning processing on the substrate to be processed W so as to clean the bonding surface Wj of the substrate to be processed W after peeling-off based on the control of the control device 60 (step S105 in FIG. 4). The glue remaining on the bonding surface Wj of the substrate to be processed W is removed by the cleaning processing of the substrate to be processed W.

Subsequently, the first conveyance apparatus 30 performs a carry-out processing of the substrate to be processed W to carry out the substrate to be processed W from the first cleaning apparatus and convey the substrate to be processed W to the carry-in/out station 11 based on the control of the control device 60 (step S106 in FIG. 4) (see, e.g., W2 in FIG. 5B). Thereafter, the substrate to be processed W is carried out from the carry-in/out station 11 to the outside and recovered. As such, the processings related to the substrate to be processed W are finished.

Meanwhile, in the second processing block 20, the processings of steps S107 to S109 are performed in parallel to the processings of steps S105 and S106.

First, in the second processing block 20, the third conveyance apparatus 50 provided in the transfer station 21 performs a transfer processing of the support substrate S after peeling-off based on the control of the control device 60 (step S107 in FIG. 4).

In step S107, the third conveyance apparatus 50 receives the support substrate S after peeling-off from the peeling apparatus (see, e.g., 51 in FIG. 5B), and disposes the support substrate S in the second cleaning apparatus of the second cleaning station 22 (see, e.g., S2 in FIG. 5B).

Here, since the support substrate S after peeling-off is held by the peeling apparatus at the top surface side, i.e., the non-bonding surface Sn side, the third conveyance apparatus 50 holds the bonding surface Sj side of the support substrate S from the lower side in the contactless manner. In addition, the third conveyance apparatus 50 carries the support substrate S held by the third conveyance apparatus 50 into the second cleaning station 22, reverses the support substrate S, and then, disposes the support substrate S in the second cleaning apparatus. As a result, the support substrate S is disposed in the second cleaning apparatus in a state where the bonding surface Sj faces upwardly. Further, the second cleaning apparatus performs a cleaning processing of the support substrate to clean the bonding surface Sj of the support substrate S based on the control of the control device 60 (step S108 in FIG. 4). The glue G remaining on the bonding surface Sj of the support substrate S is removed by the cleaning processing of the support substrate G.

Subsequently, the second conveyance apparatus 40 performs a carry-0out processing of the support substrate S based on the control of the control device 60 so as to carry out the support substrate S after peeling-off from the second cleaning apparatus and convey the support substrate S after peeling-off to the carry-out station 24 (step S109 in FIG. 4) (see, e.g., S3 in FIG. 5B). Thereafter, the support substrate S is carried out from the carry-out station 24 to the outside and recovered. As such, the processings related to the support substrate S are finished.

As described above, the peeling system 1 according to the first exemplary embodiment is configured to include a front end for a substrate held by the dicing frame F (the carry-in/out station 11) and the first conveyance apparatus 30, a front end for a substrate non-held by the dicing frame F (the carry-out station 24), and the second conveyance apparatus 40. As a result, the conveyance processing of the substrate to be processed W after peeling-off to the carry-in/out station 11 and the conveyance processing of the support substrate S after peeling-off to the carry-out station 24 may be performed in parallel. Therefore, a series of substrate processings may be efficiently performed.

In addition, in the peeling system 1 according to the first exemplary embodiment, the first processing block 10 and the second processing block 20 are connected through the transfer station 21. Therefore, the support substrate S after peeling-off may be directly taken out from the peeling station 15 and carried into the second processing block 20. As a result, the support substrate S after peeling-off may be smoothly conveyed to the second cleaning apparatus.

Accordingly, with the peeling system 1 according to the first exemplary embodiment, the throughput of a series of substrate processings may be enhanced.

<2. Configuration of Each Apparatus>

<2-1. Peeling Apparatus>

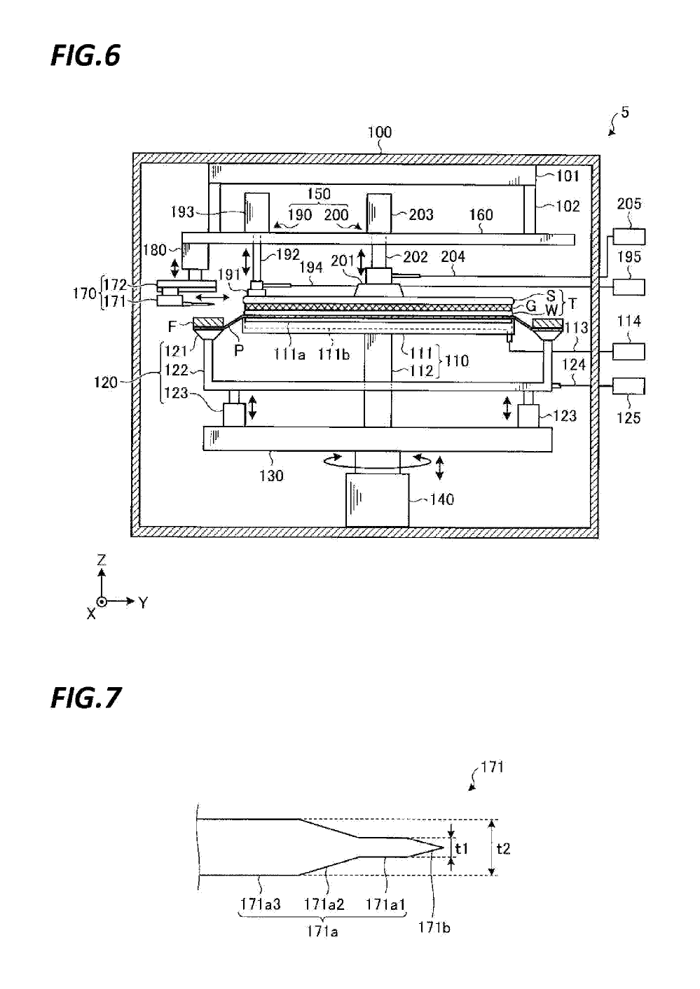

Next, the configuration of each apparatus provided in the peeling system 1 will be described in detail. First, the configuration of the peeling apparatus provided in the peeling station 15 and the peeling operations of a superimposed substrate T performed using the peeling apparatus will be described. FIG. 6 is a schematic side view illustrating the configuration of the peeling apparatus according to the first exemplary embodiment.

As illustrated in FIG. 6, the peeling apparatus 5 is provided with a processing unit 100. The processing unit 100 is formed with a carry-in/out port (not illustrate) in a side surface and the carry-in of a superimposed substrate T into the processing unit 100 or the carry-out of a substrate to be processed W and a support substrate S after peeling-off from the processing unit 100 is performed through the carry-in/out port. The carry-in/out port is provided with, for example, an opening/closing shutter. The processing unit 100 and another region are partitioned by the opening/closing shutter so that introduction of particles may be suppressed. Further, such a carry-in/out port is provided in each of a side surface adjacent to the first conveyance region 12 and a side surface adjacent to the transfer station 21.

The peeling apparatus 5 includes a first holding unit 110, a frame holding unit 120, a lower base unit 130, a rotary lift unit 140, a second holding unit 150, an upper base unit 160, a peeling inducing unit 170, and a positioning unit 180. These are arranged in the inside of the processing unit 100.

The first holding unit 110 is configured to hold the substrate to be processed W of the superimposed substrate T from the lower side and the second holding unit 150 is configured to hold the support substrate S of the superimposed substrate T from the upper side. In addition, the second holding unit 150 is configured to move the support substrate S held by the second holding unit 150 in a direction of separating the support substrate S from a surface of the substrate to be processed W. As a result, the peeling apparatus 5 separates the superimposed substrate T into the support substrate S and the substrate to be processed W. Hereinafter, each constituent element will be described in detail.

The first holding unit 110 is configured to suck and hold the substrate to be processed W that forms the superimposed substrate T through a dicing tape P.

The first holding unit 110 is provided with a disc-shaped body 111 and a strut member 112 configured to support the body 111. The strut member 112 is supported by the lower base unit 130.

The body 111 is made of a metal member of such as, for example, aluminum. A suction face 111a is provided on the top surface of the body 111. The suction face 111a has a diameter which is substantially the same as that of the superimposed substrate T and comes into contact with the bottom surface of the superimposed substrate T, that is, the non-bonding surface of the substrate to be processed W. The suction face 111a is formed of, for example, a porous member or a porous ceramic such as silicon carbide.

A suction space 111b is formed within the inside of the body 111 in which the suction space 111b communicates with the outside through the suction face 111a. The suction space 111b is connected with an intake apparatus 114 such as, for example, a vacuum pump, through an intake pipe 113.

The first holding unit 110 causes the non-bonding surface Wn of the substrate to be processed W to be sucked to the suction face 111a through the dicing tape P using a negative pressure which is generated by air-intake by the intake apparatus 114. As a result, the first holding unit 110 holds the substrate to be processed W. Although an example in which the first holding unit 110 is a porous chuck is illustrated here, the first holding unit may be any other chuck such as, for example, an electrostatic chuck.

A frame holding unit 120 configured to hold the dicing frame F from the lower side is arranged outside the first holding unit 110. The frame holding unit 120 includes a plurality of suction pads 121 configured to suck and hold the dicing frame F, a support member 122 configured to support the suction pads 121, and a moving mechanism 123 fixed to the lower base unit 130 and configured to move the support member 122 along the vertical direction.

The suction pads 121 are formed of an elastic member such as, for example, rubber and arranged at the positions corresponding to, for example, four positions around the dicing frame F as illustrated in FIG. 3, respectively. Each of the suction pads 121 is formed with an intake port (not illustrated) where an intake apparatus 125 such as, for example, a vacuum pump, is connected through the support member 122 and the intake pipe 124.

The frame holding unit 120 sucks the dicing frame F using a negative pressure which is generated by air-intake of the intake apparatus 125. As a result, the frame holding unit 120 holds the dicing frame F. In addition, the frame holding unit 120 is configured to move the support member 122 and the suction pads 121 along the vertical direction in a state in which the dicing frame F is held by the frame holding unit 120. As a result, the frame holding unit 120 moves the dicing frame F along the vertical direction.

The lower base unit 130 is arranged below the first holding unit 110 and the frame holding unit 120 and supports the first holding unit 110 and the frame holding unit 120. The lower base unit 130 is supported by a rotary lift unit 140 which is fixed to the bottom surface of the processing unit 100.

The rotary lift unit 140 rotates the lower base unit 130 around the vertical axis. Thus, the first holding unit 110 and the frame holding unit 120 supported by the lower base unit 130 are integrally rotated. Further, the rotary lift unit 140 moves the lower base unit 130 in the vertical direction. As a result, the first holding unit 110 and the frame holding unit 120 which are supported by the lower base unit 130 are integrally lifted.

A second holding unit 150 is arranged above the first holding unit 110 to face the first holding unit 110. The second holding unit 150 includes a first suction and moving unit 190 and a second suction and moving unit 200. The first suction and moving unit 190 and the second suction and moving unit 200 are supported on the upper base unit 160. The upper base unit 160 is supported on a fixing member 101 attached to a ceiling portion of the processing unit 100 through struts 102.

The first suction and moving unit 190 sucks and holds the circumferential edge of the support substrate S. In addition, the second suction and moving unit 200 sucks and holds a region which is closer to the central portion of the support substrate S than to the circumferential edge of the support substrate S. In addition, the first suction and moving unit 190 and the second suction and moving unit 200 move the regions sucked and held by them in a direction of separating the regions from the surface of the substrate to be processed W respectively and independently.

The first suction and moving unit 190 includes a suction pad 191, a strut member 192, and a moving mechanism 193. In addition, the second suction and moving unit 200 includes a suction pad 201, a strut member 202 and a moving mechanism 203.

The suction pads 191, 201 are formed of an elastic member such as rubber. Each of the suction pads 191, 201 is formed with an intake port (not illustrated), and the intake ports are connected with intake apparatuses 195, 205 such as, for example, vacuum pumps through intake pipes 194, 204, respectively.

The strut members 192, 202 support the suction pads 191, 201 at the front ends thereof. The base ends of the strut members 192, 202 are supported by the moving mechanisms 193, 203. The moving mechanisms 193, 203 are fixed to the top side of the upper base unit 160 and move the strut members 192, 202 in the vertical direction.

The first suction and moving unit 190 and the second suction and moving unit 200 suck the support substrate S using a negative pressure generated by the air-intake of the intake apparatuses 195, 205. As a result, the first suction and moving unit 190 and the second suction and moving unit 200 hold the support substrate S.

In addition, the first suction and moving unit 190 and the second suction and moving unit 200 respectively move the strut members 192, 202 and the suction pads 191, 201 along the vertical direction by the moving mechanisms 193, 203 while holding the support substrate S. As a result, the support substrate S is moved along the vertical direction.

The peeling apparatus 5 operates the moving mechanism 193 more earlier than the moving mechanism 203, that is, pulls up the support substrate S from the circumferential edge first, thereby peeling off the support substrate S from the substrate to be processed W continuously from the circumferential edge of the support substrate S toward the central portion of the support substrate S. The details of the operations will be described later.

A peeling inducing unit 170 is arranged outside the second holding unit 150. The peeling inducing unit 170 forms an area where the support substrate S starts to be peeled off from the substrate to be processed W on a side surface of the superimposed substrate T.

The peeling inducing unit 170 includes a sharp member 171 and a moving mechanism 172. The sharp member 171 is, for example, an edged tool, and is supported by the moving mechanism 172 such that the front end of the sharp member 171 protrudes toward the superimposed substrate T. Here, the shape of the sharp member 171 will be described with reference to FIG. 7. FIG. 7 is a schematic side view of the sharp member 171.

As illustrated in FIG. 7, the sharp member 171 includes a body portion 171a and a cutting edge portion 171b formed at the tip end of the body portion 171a. Further, the body portion 171a includes a first flat portion 171a1 connected to the cutting edge portion 171b and having a predetermined thickness t1, a second flat portion 171a3 positioned at the base end side of the first flat portion 171a1 and having a predetermined thickness t2 which is thicker than that of the first flat portion 171a1, and an inclined portion 171a2 that interconnects the first flat portion 171a1 and the second flat portion 171a3. The thickness t1 of the first flat portion 171a1 is, for example, about 50 μm and the thickness t2 of the second flat portion 171a3 is, for example, about 400 μm.

As described above, the body portion 171a of the sharp member 171 has the first flat portion 171a1. As a result, the load applied to the substrate to be processed W when the sharp member 171 is introduced between the support substrate S and the glue G may be reduced as compared with a conventional edged tool having the first flat portion 171a1. In addition, the body portion 171a of the sharp member 171 has the second flat portion 171a3 which is thicker than the first flat portion 171a1. As a result, the strength of the sharp member 171 may be secured so that the sharp member 171 may be suppressed from being bent or chipped when a force is applied to the support substrate S with the sharp member 171 as a fulcrum.

In addition, the sharp member 171 is formed of a hard metal. This also enables the strength of the sharp member 171 to be secured when the force is applied to the support substrate S with the sharp member 171 as the fulcrum.

When a ceramic resin-based edged tool or a fluorine-coated edged tool is used as for the sharp member 171, occurrence of particles when the sharp member 171 is inserted into the superimposed substrate T may be suppressed. Further, as for the sharp member 171, for example, a razor blade, a roller blade, or a supersonic cutter may be used.

The moving mechanism 172 moves the sharp member 171 along a rail extending in the Y-axis direction. The peeling apparatus 5 moves the sharp member 171 using the moving mechanism 172 so as to cause the sharp member 171 to come into contact with a side surface portion of the support substrate S adjacent to the glue G. As a result, the peeling apparatus 5 forms an area where the support substrate S starts to be peeled off from the substrate to be processed W (hereinafter, referred to as a “peeling initiation area”) on the side surface of the superimposed substrate T.

In addition, the moving mechanism 172 is supported by a positioning unit 180 from the upper side. The positioning unit 180 is fixed to, for example, the bottom portion of the upper base unit 160 and moves the moving mechanism 172 along the vertical direction. Thus, the height position of the sharp member 171, that is, the contact position in relation to the side surface of the superimposed substrate T may be adjusted.

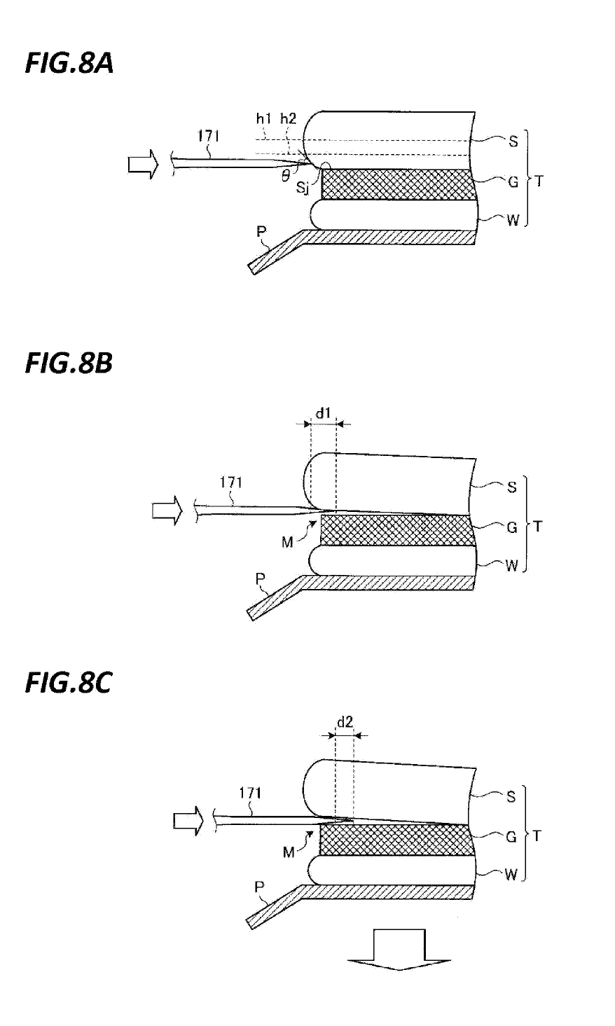

Now, the peeling inducing processing performed using the peeling inducing unit 170 will be described in detail with reference to FIGS. 8A to 8C. FIGS. 8A to 8C are explanatory views illustrating the operations of the peeling inducing processing.

The peeling inducing processing illustrated in FIGS. 8A to 8C is performed after the substrate to be processed W of the superimposed substrate T is held by the first holding unit 110 (see, e.g., FIG. 6) and before the support substrate S is held by the second holding unit 150. That is, the peeling inducing processing is performed in the state where the support substrate S is free. Further, the peeling apparatus performs the peeling inducing processing illustrated in FIGS. 5 and 8A to 8C based on the control of the control device 60.

The peeling apparatus 5 adjusts the height position of the sharp member 171 using the positioning unit 180 and then moves the sharp member 171 toward the side surface of the superimposed substrate T using the moving mechanism 172(see, e.g., FIG. 6). Specifically, as illustrated in FIG. 8A, the sharp member 171 is moved substantially horizontally toward a side surface portion of the support substrate S adjacent to the glue G in the side surface of the superimposed substrate T.

The “side surface portion of the support substrate S adjacent to the glue G” refers to a portion which is closer to the bonding surface Sj than the position of one half of the thickness of the support substrate S in the side surface of the support substrate S. That is, the side surface portion of the support substrate S is formed in a substantially circular arc shape and the “side surface portion of the support substrate S adjacent to the glue G” is a side surface portion where an angle θ formed with the sharp member 171 is not less than 0 degrees and not more than 90 degrees when it is assumed that the angle between the sharp member 171 and the bonding surface Sj is 0 degrees.

First, the peeling apparatus 5 moves the sharp member 171 forward to a predetermined position (preliminary forward movement). Then, the peeling apparatus 5 moves the sharp member 171 further forward so that the sharp member 171 comes into the side surface portion of the support substrate S adjacent to the glue G. In addition, the peeling inducing unit 170 is provided with, for example, a load cell (not illustrated). The peeling apparatus 5 detects the load applied to the sharp member 171 using the load cell so as to detect whether the sharp member 171 is in contact with the support substrate S.

As described above, the side surface of the support substrate S is formed in the substantially circular arc shape. Accordingly, when the sharp member 171 comes into contact with the side portion of the support substrate S adjacent to the glue G, an upward force is applied to the support substrate S.

Subsequently, as illustrated in FIG. 8B, the peeling apparatus 5 moves the sharp member 171 further forward. Thus, the support substrate S is pushed upward along the curve of the side surface. As a result, a part of the support substrate S is peeled off from the glue G to form a peeling initiation area M.

In addition, since the support substrate S is in the free state without being held by the second holding unit 150, the upward movement of the support substrate S is not obstructed. In the present processing, the distance d1 of moving the sharp member 171 forward is, for example, about 2 mm.

Subsequently, as illustrated in FIG. 8C, the peeling apparatus 5 moves the sharp member 171 further forward while moving the first holding unit 110 downward using the rotary lift unit 140 (see, e.g., FIG. 6). Thus, a downward force is applied to the substrate to be processed W and the glue G and only an upward force is applied to the support substrate S supported by the sharp member 171. When the sharp member 171 is moved further forward by the moving mechanism 172 while moving the first holding unit 110 downward by the rotary lift unit 140 in this manner, the peeling initiation area M may be expanded. The rotary lift unit 140 is an example of the first holding unit moving mechanism that moves the first holding unit 110 in the direction of separating the substrate to be processed W from the support substrate S.

Since the sharp member 171 is formed in the shape as illustrated in FIG. 7, the load applied to the substrate to be processed W when the sharp member 171 is introduced between the support substrate S and the glue G may be reduced. In the present processing, the distance d2 of moving the sharp member 171 forward is, for example, about 1 mm.

As described above, when the peeling apparatus 5 causes the sharp member 171 to butt against the side surface portion of the support substrate S adjacent to the glue G, the peeling initiation area M where the support substrate S starts to be peeled off from the substrate to be processed W may be formed on the side surface of the superimposed substrate T.

The support substrate S is about 5 to 15 times as thick as the glue G. Accordingly, it is easy to control the vertical position control of the sharp member 171 as compared with a case in which the sharp member 171 comes into contact with the glue G so as to form a peeling initiation area.

In addition, when the sharp member 171 comes into contact with the side surface portion of the support substrate S adjacent to the glue G, a force in the direction peeling off the support substrate S from the substrate to be processed W (i.e., upward force) may be applied to the support substrate S. Further, since an area adjacent to the outermost edge of the support substrate S is moved up, the force in the direction of peeling off the support substrate S from the substrate to be processed W may be efficiently applied to the support substrate S.

In addition, the probability of causing the sharp member 171 to be contacted with the substrate to be processed W may be reduced as compared with a case in which the sharp member 171 is butted against the glue G.

Further, as illustrated in FIG. 8A, the “side surface portion of the support substrate S adjacent to the glue G is more preferably a side surface portion up to the position h2 of ¼ of the thickness of the support substrate S from the bonding surface Sj of the support substrate S. That is, it is desirable that the angle θ formed with the sharp member 171 is not less than 0 degrees and not more than 45. This is because as the angle θ formed with the sharp member 171 is reduced, the force for moving up the support substrate S may be increased.

In addition, when the bonding force between the support substrate S and the glue G is relatively weak, the peeling initiation area M may be formed merely by contacting the sharp member 171 to the side surface portion of the support substrate S adjacent to the glue G as illustrated in FIG. 8A. In such a case, the peeling apparatus 5 may omit the operations as illustrated in FIGS. 8B and 8C.

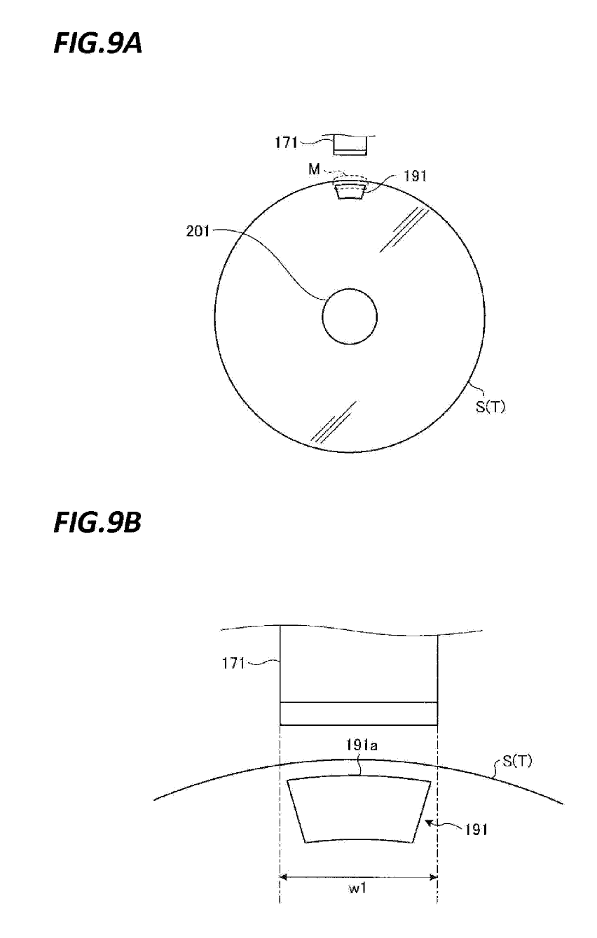

Next, arrangements of the first suction and moving unit 190, the second suction and the moving unit 200 or the like will be described with reference to FIGS. 9A and 9B. FIG. 9A is a schematic plan view illustrating a suction pad 191 provided in the first suction and moving unit 190 and a suction pad 201 provided in the second suction and moving unit 200. FIG. 9B is a schematic enlarged view illustrating the suction pad 191 provided in the first suction and moving unit 190.

As illustrated in FIG. 9A, the suction pad 191 provided in the first suction and moving unit 190 sucks the circumferential edge of the support substrate S corresponding to the peeling initiation area M. In addition, the suction pad 201 provided in the second suction and moving unit 200 sucks the central portion of the support substrate S.

The suction pad 191 is formed with a suction area to be smaller than that of the suction pad 201. This is because, when the suction pad 191 is formed to be small, only the circumferential edge of the support substrate corresponding to the area where the peeling initiation area M is formed may be sucked and pulled up. Thus, the circumferential edge portion where the peeling initiation area M is not formed may be suppressed from being sucked and pulled up to reduce the peeling force.

As illustrated in FIG. 9B, the suction pad 191 is preferably formed to be smaller than the edge width w1 of the sharp member 171. Therefore, it may be assured that the circumferential edge portion of the support substrate S where the peeling initiation area M is not formed is prevented from being sucked by the suction pad 191. In other words, only the circumferential edge portion of the support substrate S where the peeling initiation area M is formed may be correctly sucked. Further, the suction pad 201 is formed to be larger than the edge width w1.

In addition, as illustrated in FIG. 9B, the suction pad 191 has a portion 191a which corresponds to the outer edge of the support substrate S and is formed in an arc shape along the outer edge of the support substrate S. Thus, the suction pad 191 may be arranged at a region closer to the outermost edge of the support substrate S. Accordingly, the force in the direction of peeling off the support substrate S from the substrate to be processed W may be efficiently applied to the support substrate S.

As illustrated in FIG. 9A, the suction pad 191 and the suction pad 201 are arranged along the moving direction of the sharp member 171. When the peeling apparatus 5 pulls up the suction pad 191 earlier than the suction pad 201, that is, when the support substrate S is pulled up from the circumferential edge thereof firstly, the support substrate S is continuously peeled off from the substrate to be processed W from the circumferential edge toward the central portion of the support substrate S.

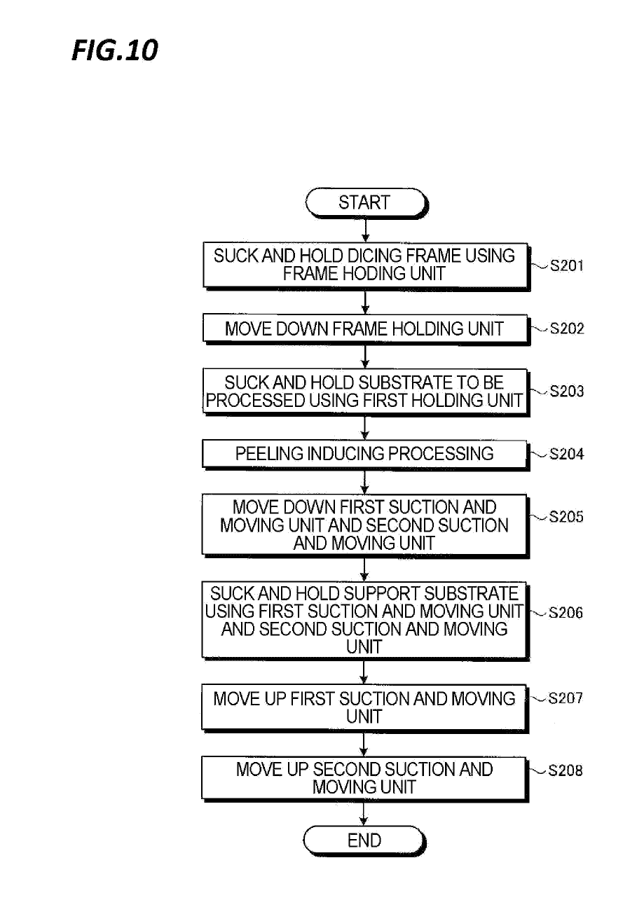

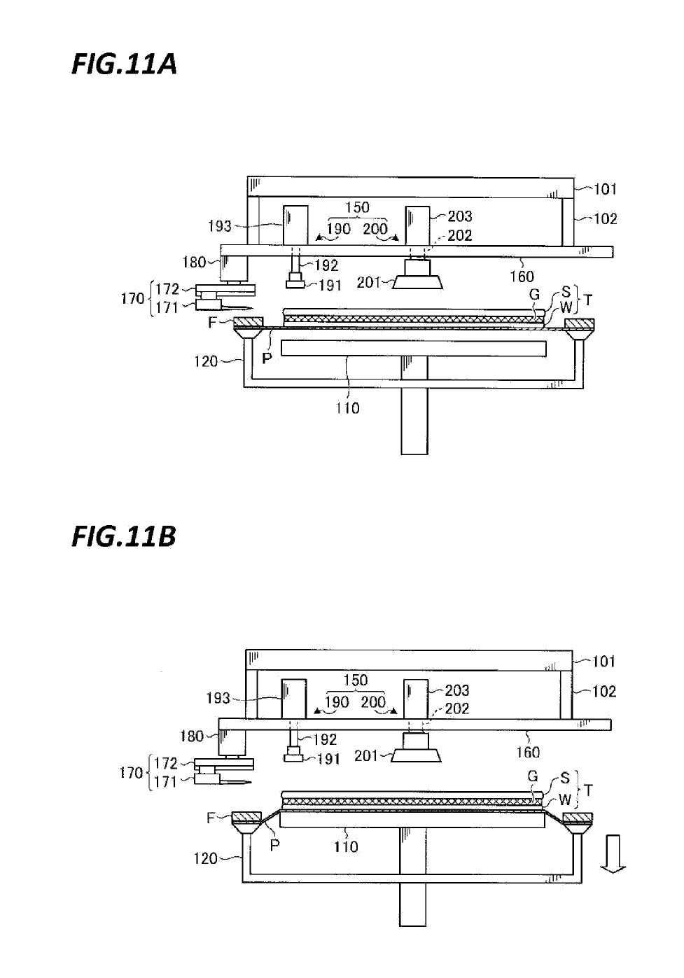

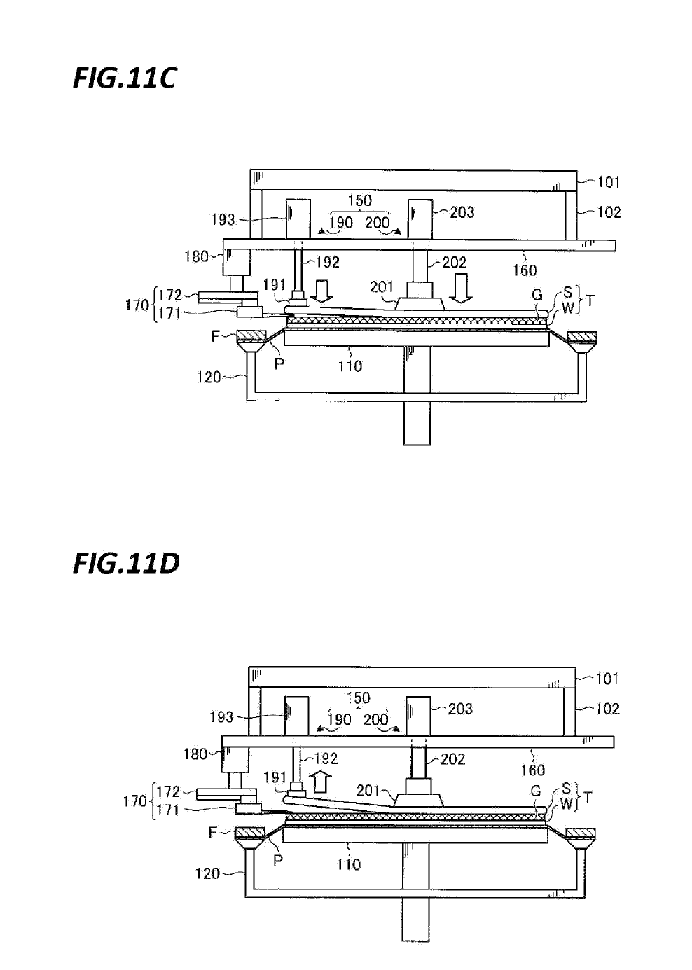

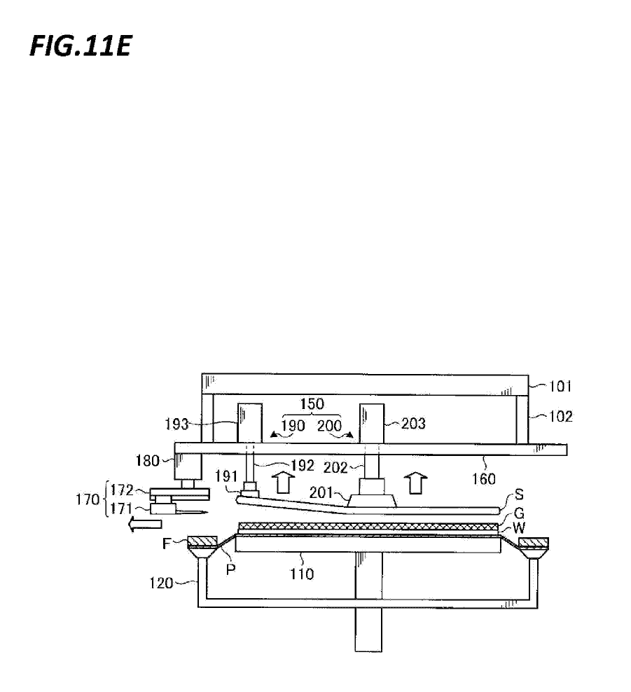

Details of the peeling operations will be described with reference FIGS. 10 and 11A to 11E. FIG. 10 is a flowchart illustrating a peeling processing sequence. FIGS. 11A to 11E are explanatory views illustrating peeling operations. In addition, the peeling apparatus 5 performs the respective processing sequence illustrated in FIG. 10.

First, the peeling apparatus 5 sucks and holds the dicing frame F of the superimposed substrate T carried into the peeling station 15 by the first conveyance apparatus 30 using the frame holding unit 120 from the lower side of the dicing frame F (step S201). In that event, the superimposed substrate T is in a state where it is held only by the frame holding unit 120 (see, e.g., FIG. 11A).

Subsequently, the peeling apparatus 5 moves down the frame holding unit 120 using the moving mechanism 123 (see, e.g., FIG. 6) (step S202). Thus, the substrate to be processed W of the superimposed substrate T comes into contact with the first holding unit 110 through the dicing tape P (see, e.g., FIG. 11B). Thereafter, the peeling apparatus 5 sucks and holds the substrate to be processed W through the dicing tape P using the first holding unit 110 (step S203). As a result, the superimposed substrate T is in the state where the substrate to be processed W is held by the first holding unit 110 and the dicing frame F is held by the frame holding unit 120.

Then, the peeling apparatus 5 performs the peeling inducing processing described above with reference to FIGS. 8A to 8C (step S204). As a result, a peeling initiation area M (see, e.g., FIG. 8B) is formed on the side surface of the superimposed substrate T.

Subsequently, the peeling apparatus 5 moves down the suction pad 191 of the first suction and moving unit 190 and the suction pad 201 of the second suction and moving unit 200 (step S205). As a result, the suction pads 191, 201 come into contact with the non-bonding surface Sn (see, e.g., FIG. 2) of the support substrate S (see, e.g., FIG. 11C). Then, the peeling apparatus 5 sucks and holds the non-bonding surface Sn of the support substrate S using the first suction and moving unit 190 and the second suction and moving unit 200 (step S206). As described above, the first suction and moving unit 190 sucks and holds the circumferential edge portion of the support substrate S corresponding to the peeling initiation area M and the second suction and moving unit 200 sucks and holds the central portion of the support substrate S.

Subsequently, of the suction pads 191, 201, the peeling apparatus 5 moves up the suction pad 191 only (step S207). That is, the peeling apparatus 5 pulls up the circumferential edge portion of the support substrate S corresponding to the peeling initiation area M. As a result, the support substrate S starts to be peeled off continuously from the substrate to be processed W from the circumferential edge portion toward the central portion of the support substrate S (see, e.g., FIG. 11D).

Then, the peeling apparatus 5 moves up the suction pad 201 (step S208). That is, the peeling apparatus 5 further pulls up the central portion of the support substrate S while pulling up the circumferential edge portion of the support substrate S corresponding to the peeling initiation area M. As a result, the support substrate S is peeled off from the substrate to be processed W (see, e.g., FIG. 11E).

Then, the peeling apparatus 5 moves up the second suction and moving unit 200 only or moves down the first suction and moving unit 190 only so as to position the support substrate S horizontally and then moves back the sharp member 171 to finish the peeling processing.

As described above, the peeling apparatus 5 is configured such that, after the first suction and moving unit 190 moves the circumferential edge in the direction of separating the support substrate S from the substrate to be processed W, the second suction and moving unit 200 moves the central portion of the support substrate S in the direction of peeling off the support substrate S from the surface of the substrate to be processed W.

As a result, the superimposed substrate T may be separated into the support substrate S and the substrate to be processed W without applying a large load to the support substrate S.

That is, for example, when a superimposed substrate is peeled off by using the circumferential edge of one side of the superimposed substrate as a fulcrum and pulling up the circumferential edge of other side as in the technology disclosed in Japanese National Phase Patent Laid-Open Publication 2007-526628, there is a problem in that the support substrate is greatly bent as the peeling proceeds. On the contrast, according to the peeling apparatus 5, since the peeling operation is performed using the first suction and moving unit 190 configured to suck and hold the circumferential edge of the support substrate S and the second suction and moving unit 200 configured to suck and hold the central portion of the support substrate S, the peeling-off may proceed while suppressing the deformation of the support substrate S.

In addition, with the peeling apparatus 5, the superimposed substrate T may be peeled off within a short time as compared with the case in which only the first suction and moving unit 190 is used.

In addition, the peeling apparatus 5 may rotate the first holding unit 110 and the frame holding unit 120 using the rotary lift unit 140 after the substrate to be processed W and the support substrate S are separated from each other. As a result, when the glue G exists over the support substrate S and the substrate to be processed W, the glue G may be twisted and cut off.

When the peeling apparatus 5 finishes the peeling processing, the third conveyance apparatus 50 (see, e.g., FIG. 1) receives the support substrate S after peeling-off from the peeling apparatus 5 and disposes the received support substrate S in the second cleaning apparatus in the second cleaning station 22 (see, e.g., FIG. 1).

Here, the support substrate S after peeling-off is in the state where the non-bonding surface Sn side is held by the first suction and moving unit 190 and the second suction and moving unit 200 and the third conveyance apparatus 50 holds the bonding surface Sj side of the support substrate S from the lower side in a contactless manner. As described above, the second holding unit 150 also serves as a transfer unit that transfers the support substrate S after peeling-off to the third conveyance apparatus 50. In the first exemplary embodiment, the support substrate S after peeling-off may be stably held because the second suction and moving unit 200 is configured to suck the central portion of the support substrate S.

In addition, the first conveyance apparatus 30 (see, e.g., FIG. 1) carries out the substrate to be processed W after peeling-off from the peeling apparatus 5 and conveys the substrate to be processed W to the first cleaning station 16. In that event, the substrate to be processed W after peeling-off is held by the first holding unit 110 in the state where the boning surface Wj to be cleaned is positioned at the top side as illustrated in FIG. 11E. For this reason, the first conveyance apparatus 30 may convey the substrate to be processed W after peeling-off to the first cleaning station 16 as it is without reversing the substrate to be processed W after carrying out the substrate to be processed W from the peeling apparatus 5.

As described above, in the peeling apparatus 5, the first holding unit 110 is configured to hold the substrate to be processed W from the lower side and the second holding unit 150 is configured to hold the support substrate S of the superimposed substrate T from the upper side. Thus, it is not required to reverse the substrate to be processed W, which may make the peeling processing efficient.

<2-2. Configuration of First Cleaning Apparatus>

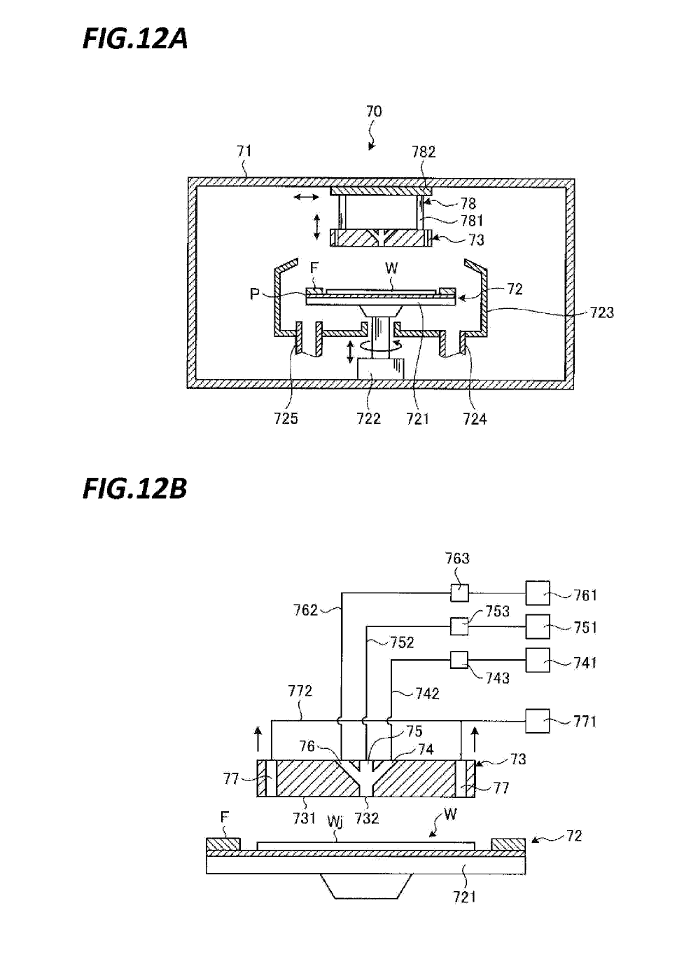

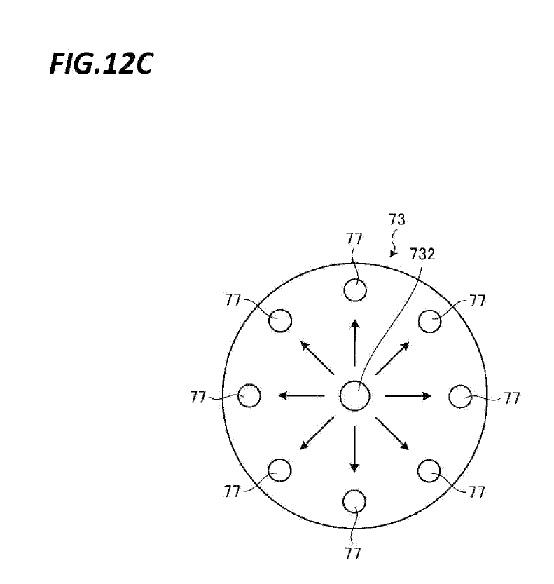

Next, the configuration of the first cleaning apparatus will be described with reference to FIGS. 12A to 12C. FIGS. 12A and 12B are schematic side views illustrating the configuration of the first cleaning apparatus. In addition, FIG. 12C is a schematic plan view illustrating a configuration of a cleaning jig.

As illustrated in FIG. 12A, the first cleaning apparatus 70 has a processing container 71. A carry-in/out port (not illustrated) of a substrate to be processed W is formed in a side surface of the processing container 71 and an opening/closing shutter (not illustrated) is provided in the carry-in/out port. Further, a filter (not illustrated) is provided inside the processing container 71 so as to purify the internal atmosphere of the processing container 71.

A substrate holding unit 72 is arranged at a central portion within the processing container 71. The substrate holding unit 72 has a spin chuck 721 configured to hold and rotate a dicing frame F and a substrate to be processed W.

The spin chuck 721 has a horizontal top surface which is formed with a suction port (not illustrated) configured to suck, for example, a dicing tape P. In addition, the substrate to be processed W is sucked and held on the spin chuck 721 through the dicing tape P by the suction from the suction port. In that event, the substrate to be processed W is sucked and held on the spin chuck 721 to that the bonding surface Wj of the substrate to be processed W faces upwardly.

A chuck drive unit 722 which is provided with, for example, a motor, is arranged below the spin chuck 721. The spin chuck 721 is rotated at a predetermined speed by the chuck drive unit 722. In addition, the chuck drive unit 722 is provided with a lift drive source such as, for example, a cylinder, and the spin chuck 721 is lifted by the lift drive source.

A cup 723 configured to receive and recover liquid scattered or dropped from the substrate to be processed W is disposed to surround the substrate holding unit 72. A discharge pipe 724 configured to discharge the recovered liquid and an exhaust pipe 725 configured to exhaust the atmosphere within the cup 723 are connected to the bottom of the cup 723.

A cleaning jig 73 configured to clean the bonding surface Wj of the substrate to be processed W is arranged above the substrate holding unit 72. The cleaning jig 73 is arranged opposite to the substrate to be processed W held by the substrate holding unit 72. Here, the configuration of the cleaning jig 73 will be described with reference to FIGS. 12B and 12C.

As illustrated in FIGS. 12B and 12C, the cleaning jig 73 is substantially disc-shaped. A supply face 731 is formed on the bottom of the cleaning jig 73 to cover at least the bonding surface Wj of the substrate to be processed W. In addition, in the present exemplary embodiment, the supply face 731 is formed in a size which is substantially the same as that of the bonding surface Wj of the substrate to be processed W.

At the central portion of the cleaning jig 73, a solvent supply portion 74 configured to supply a solvent of the glue G, for example, a thinner, to a space between the supply face 731 and the bonding surface Wj, a rinse liquid supply portion 75 configured to supply a rinse liquid of rinsing the solvent, and an inert gas supply portion 76 configured to supply an inert gas, for example, nitrogen gas are provided. The solvent supply portion 74, the rinse liquid supply portion 75 and the inert gas supply portion 76 join within the cleaning jig 73 and communicate with a supply port 732 formed in the supply face 731 of the cleaning jig 73. That is, the solvent flow path from the solvent supply portion 74 to the supply port 732, the rinse liquid flow path from the rinse liquid supply portion 75 to the supply port 732 and the inert gas flow path from the inert gas supply portion 76 to the supply port 732 respectively penetrate the cleaning jig 73 in the thickness direction of the cleaning jig 73. In addition, in the rinse liquid, various liquids are used depending on the components of a main solvent of the glue G and, for example, pure water or isopropyl alcohol (IPA) is used. In addition, in order to facilitate the dry of the rinse liquid, a high volatile liquid is preferably used in the rinse liquid.

A supply pipe that communicates with a solvent supply source 741 configured to store the solvent therein is connected to the solvent supply portion 74. The supply pipe 742 is provided with a supply device group 743 that includes, for example, a valve or a flow rate control unit configured to control the flow of the solvent. A supply pipe 752 that communicates with a rinse liquid supply source 751 configured to store the rinse liquid therein is connected to the rinse liquid supply portion 75. The supply pipe 752 is provided with a supply device group 753 that includes, for example, a valve or a flow rate control unit configured to control the flow of the rinse liquid. A supply pipe 762 that communicates with an inert gas supply source 761 configured to store the inert gas therein is connected to the inert gas supply portion 76. The supply pipe 762 is provided with a supply device group 763 that includes, for example, a valve or a flow rate control unit configured to control the flow of the solvent.

The cleaning jig 73 is provided with suction portions 77 along the outer periphery thereof which are configured to suck the solvent or the rinse liquid at a gap between the supply face 731 and the bonding surface Wj. The suction portions 77 are provided to penetrate the cleaning jig 73 in the thickness direction. In addition, the suction portions 77 are arranged at a plurality of locations (e.g., 8 locations) on the same circumference as the cleaning jig 73 to be equidistantly spaced (see, e.g., FIG. 12C). An intake pipe 772 that communicates with a negative pressure generation apparatus 771 such as, for example, a vacuum pump, is connected to each of the suction portions 77.

As illustrated in FIG. 12A, on the ceiling surface of the processing container 71 above the cleaning jig 73, a moving mechanism 78 is provided which is configured to move the cleaning jig 73 vertically as well as horizontally. The moving mechanism 78 includes a support member 781 configured to support the cleaning jig 73 and a jig drive unit 782 configured to support the support member 781 and to move the cleaning jig 73 vertically as well as horizontally.

The first conveyance apparatus 30 holds the substrate to be processed W after peeling-off by holding the dicing frame F from the upper side which is held from the lower side by the frame holding unit 120 (see, e.g., FIG. 6) of the peeling apparatus 5. In addition, the first conveyance apparatus 30 disposes the held substrate to be processed W on the spin chuck 721 of the first cleaning apparatus 70. As a result, the substrate to be processed W after peeling-off is disposed on the spin chuck 721 in a state where the bonding surface Wj is positioned at the top side.

Then, the first cleaning apparatus 70 performs a cleaning processing of the substrate to be processed W disposed on the substrate holding unit 72 (first cleaning processing) based on the control of the control device 60.

First, the first cleaning apparatus 70 sucks and holds the substrate to be processed W and the dicing frame F through the dicing tape P using the spin chuck 721. Subsequently, the first cleaning apparatus 70 adjusts the horizontal position of the cleaning jig 73 by the moving mechanism 78 and then, moves down the cleaning jig 73 to a predetermined position. In that event, the distance between the supply face 731 of the cleaning jig 73 and the bonding surface Wj of the substrate to be processed W is set in such a manner that the distance may allow the solvent of the glue G to be diffused between the supply face 731 and the bonding surface Wj by surface tension, which will be described later.

Then, the first cleaning apparatus 70 supplies the solvent to the solvent supply portion 74 from the solvent supply source 741 while rotating the substrate to be processed W by the spin chuck 721. The solvent is supplied from the supply port 732 to the space between the supply face 731 and the bonding surface Wj and in the space, diffused on the bonding surface of the substrate to be processed W by the surface tension of the solvent and centrifugal force generated by the rotation of the substrate to be processed W. In that event, the first cleaning apparatus 70 suppresses the solvent from being introduced onto the dicing tape P by properly sucking the solvent by the suction portions 77. As a result, the strength of the dicing tape P may not be weakened by the solvent. In this manner, the solvent is supplied to the entire bonding surface Wj of the substrate to be processed W.

Then, the first cleaning apparatus 70 remains for a predetermined length of time, for example, several minutes in a state in which the bonding surface Wj of the substrate to be processed W is immersed in the solvent. Then, impurities such as the glue G remaining on the bonding surface Wj are removed by the solvent.

Thereafter, the first cleaning apparatus 70 moves up the cleaning jig 73 to a predetermined position while continuously performing the rotation of the substrate to be processed W by the spin chuck 721 and the suction of the solvent by the suction portions 77. Subsequently, the first cleaning apparatus 70 supplies the rinse liquid from the rinse liquid supply source 751 to the rinse liquid supply portion 75. The rinse liquid is diffused on the bonding surface Wj of the substrate to be processed W by the surface tension and the centrifugal force while being mixed with the solvent. As a result, the mixture of the solvent and the rinse liquid is supplied to the entire bonding surface Wj of the substrate to be processed W.

Then, the cleaning jig 73 is moved down to a predetermined position while continuously performing the rotation of the substrate to be processed W by the spin chuck 721 and the suction by the suction portions 77. In addition, an inert gas is supplied from the inert gas supply source 761 through the inert gas supply portion 76 and the supply port 732. The inert gas causes the mixture of the solvent and the rinse liquid to flow to the outside of the substrate to be processed W. As a result, the mixture of the solvent and the rinse liquid is sucked from the suction portions 77 and removed from the boding surface Wj of the substrate to be processed W.

Thereafter, the first cleaning apparatus 70 dries the substrate to be processed W by continuously performing the rotation of the substrate to be processed W by the spin chuck 721 and the supply of the inert gas. As a result, the cleaning processing of the substrate to be processed W (the first cleaning processing) is completed. The substrate to be processed W after peeling-off is carried out from the first cleaning apparatus 70 by the first conveyance apparatus 30 and conveyed to a cassette Cw in the carry-in/out station 11.

<2-3. Configuration of Third Conveyance Apparatus>

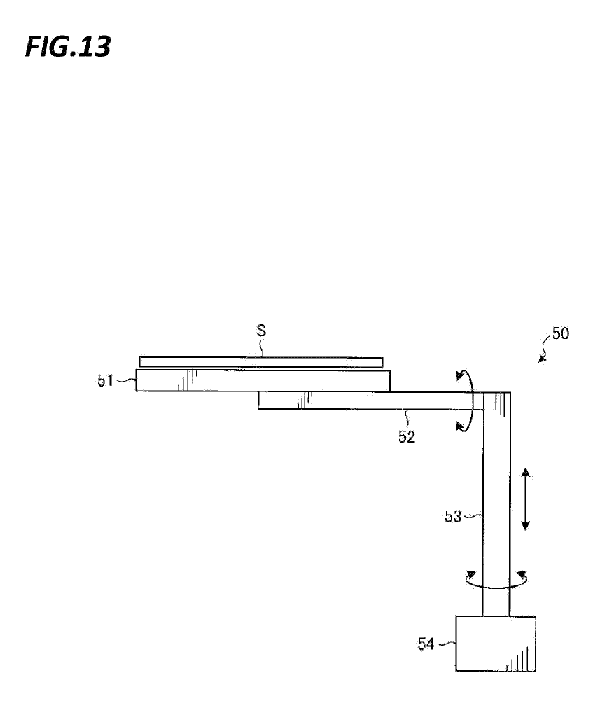

Next, the configuration of the third conveyance apparatus 50 provided in the transfer station 21 will be described with reference to FIG. 13. FIG. 13 is a schematic side view illustrating the configuration of the third conveyance apparatus 50.

As illustrated in FIG. 13, the third conveyance apparatus 50 is provided with a Bernoulli chuck 51 configured to hold the substrate to be processed W. The Bernoulli chuck 51 is configured to hold the substrate to be processed W in a contactless manner by injecting a gas from an injection hole formed in a suction face toward the surface of a substrate to be processed W and using a variation of negative pressure caused when the flow rate of the gas is varied depending on the spacing between the suction face and the surface of the substrate to be processed W.

Further, the third conveyance apparatus 50 includes a first arm 52, a second arm 53, and a base portion 54. The first arm 52 extends horizontally to support the Bernoulli chuck 51 at the front end portion thereof. The second arm 53 extends vertically to support the base end portion of the first arm 52 at the front end portion thereof. At the front end portion of the second arm 53, a drive mechanism configured to rotate the first arm 52 around a horizontal axis is provided. When the first arm 52 is rotated around the horizontal axis using the drive mechanism, the Bernoulli chuck 51 may be reversed.

The base end portion of the second arm 53 is supported by the base portion 54. The base portion 54 is provided with a drive mechanism configured to rotate and lift the second arm 53. When the second arm 53 is rotated or lifted using the drive mechanism, Bernoulli chuck 51 may be rotated around the vertical axis or lifted.

The third conveyance apparatus 50 is configured as described above and performs a transfer processing based on the control device 60 to receive a support substrate S after peeling-off from the peeling apparatus 5 and transfers the support substrate S to the second cleaning apparatus 80.

Specifically, the support substrate S held from the upper side by the first holding unit 110 of the peeling apparatus 5 is held from the lower side by the third conveyance apparatus 50 using the Bernoulli chuck 51. As a result, the support substrate S is held by the Bernoulli chuck 51 in the state where the non-bonding surface Sn faces upwardly. Subsequently, the third conveyance apparatus 50 turns the Bernoulli chuck 51 by rotating the second arm 53 around the vertical axis. As a result, the support substrate S held by the Bernoulli chuck 51 is moved from the peeling station 15 to the second cleaning station 22 via the transfer station 21.

Subsequently, the third conveyance apparatus 50 reverses the Bernoulli chuck 51 by rotating the first arm 52 around the horizontal axis. As a result, the support substrate S is in the state where the non-bonding surface Sn faces downwardly. In addition, the third conveyance apparatus 50 moves down the Bernoulli chuck 51 by moving down the second arm 53 and disposes the support substrate S held by the Bernoulli chuck 51 in the second cleaning apparatus. As a result, the support substrate S is disposed in the second cleaning apparatus in the state where the bonding surface Sj faces upwardly and bonding surface Sj is cleaned by the second cleaning apparatus.

<2-4. Configuration of Second Cleaning Apparatus>

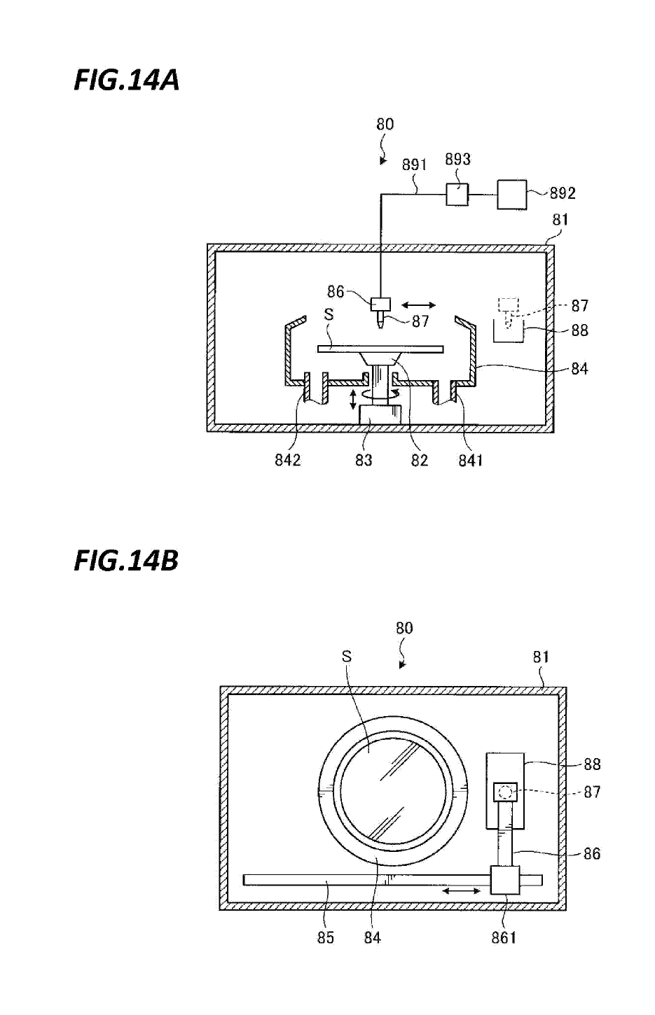

Next, the configuration of the second cleaning apparatus provided in the second cleaning station 22 will be described with reference to FIGS. 14A and 14B. FIG. 14A is a schematic side view illustrating the configuration of the second cleaning apparatus and FIG. 14B is a schematic plan view illustrating the configuration of the second cleaning apparatus.

As illustrated in FIG. 14A, the second cleaning apparatus 80 includes a processing container 81. The processing container 81 is formed with a carry-in/out port (not illustrated) of a support substrate S in a side surface thereof and an opening/closing shutter (not illustrated) is provided in the carry-in/out port.

At the central portion of the processing container 81, a spin chuck 82 is arranged which is configured to hold and rotate the support substrate S. The spin chuck 82 has a horizontal top surface in which a suction port (not illustrated) configured to suck the support substrate S is formed. The support substrate S is sucked and held on the spin chuck 82 by the suction from the suction port.

A chuck drive unit 83 provided with, for example, a motor is arranged under the spin chuck 82. The chuck drive unit 83 rotates the spin chuck 82 at a predetermined speed. Further, the chuck drive unit 83 is provided with a lift drive source such as, for example, a cylinder and the spin chuck 82 is configured to be liftable.

A cup 84 is arranged to surround the spin chuck 82 so as to receive and recover liquid scattered or dropped from the support substrate S. A discharge pipe 841 configured to discharge the recovered liquid 841 and an exhaust pipe 842 configured to exhaust the atmosphere within the cup to a vacuum state are connected to the bottom of the cup 84.

As illustrated in FIG. 14B, the processing container 81 is provided with a rail 85 to which the base end portion of the arm 86 is attached. In addition, at the front end portion of the arm 86, a cleaning liquid nozzle 87 configured to supply a cleaning liquid (e.g., an organic solvent) to the support substrate S is supported.

The arm 86 is movable along the rail 85 by the nozzle drive unit 861. As a result, the cleaning liquid nozzle 87 may be moved from a standby unit 88 provided at a side of the cup 84 to a position above the central portion of the support substrate within the cup 84 and may be moved on the support substrate S in the radial direction of the support substrate S. Further, the arm 86 may be lifted by the nozzle drive unit 861 and thus, the height of the cleaning liquid nozzle 87 may be adjusted.

As illustrated in FIG. 14A, a supply pipe 891 configured to supply a cleaning liquid to the cleaning liquid nozzle 87 is connected to the cleaning liquid nozzle 87. The supply pipe 891 communicates with a cleaning liquid supply source 892 configured to store the cleaning liquid therein. The supply pipe 891 is provided with a supply device group 893 that includes, for example, a valve or a flow rate control unit configured to control the flow of the cleaning liquid.

The second cleaning apparatus 80 is configured as described above and performs a cleaning processing (second cleaning processing) of the support substrate S conveyed by the third conveyance apparatus 50.

Specifically, the support substrate S after peeling-off is disposed on the spin chuck 82 of the second cleaning apparatus 80 by the third conveyance apparatus 50 in the state where the bonding surface Sj faces upwardly. The second cleaning apparatus 80 sucks and holds the support substrate S using the spin chuck 82 and then, moves down the spin chuck 82 to a predetermined position. Subsequently, the cleaning liquid nozzle 87 of the standby unit 88 is moved by the arm 86 to a position above the central portion of the support substrate S. Thereafter, the second cleaning apparatus 80 supplies the cleaning liquid from the cleaning liquid nozzle 87 to the bonding surface Sj of the support substrate S while rotating the support substrate S by the spin chuck 82. The cleaning liquid as being supplied is diffused over the entire bonding surface Sj of the support substrate S by the centrifugal force so that the bonding surface Sj is cleaned.

The support substrate S after peeling-off is carried out from the second cleaning apparatus 80 by the second conveyance apparatus 40 and accommodated within a cassette Cs in the carry-out station 24.

Further, a lift pin (not illustrated) configured to support and lift from the lower side of the support substrate S may be provided under the spin chuck 82. In such a case, the lift pin is configured to be inserted through a through hole (not illustrated) formed in the spin chuck 82 to be capable of protruding from the top surface of the spin chuck 82. In addition, the transfer of the support substrate S is performed between the spin chuck 82 and the lift pin by lifting the lift pin instead of lifting the spin chuck 82.

In addition, in the second cleaning apparatus 80, a back rinse nozzle (not illustrated) may be provided below the spin chuck 82 to inject the cleaning liquid toward the rear surface of the support substrate S, that is, the non-bonding surface (Sn) (see, e.g., FIG. 2). The non-bonding surface Sn of the support substrate S and the outer circumference of the support substrate S may be cleaned by the cleaning liquid injected from the back rinse nozzle.

As described above, the peeling apparatus 5 according to the first exemplary embodiment includes the first holding unit 110, the second holding unit 150, and the peeling inducing unit 170. In a superimposed substrate T in which a substrate to be processed W (an example of a first substrate) and a support substrate S (an example of a second substrate) are bonded to each other, the first holding unit 110 holds the substrate to be processed W. The second holding unit 150 holds the support substrate S in the superimposed substrate T and moves the support substrate S in a direction of separating the support substrate S from the surface of the substrate to be processed W. The peeling inducing unit 170 forms a peeling initiation area M where the support substrate S starts to be peeled off from the substrate to be processed W on the surface of the superimposed substrate T.

In addition, in the peeling apparatus 5 according the first exemplary embodiment, the peeling inducing unit 170 includes the sharp member 171 and the moving mechanism 172 configured to move the sharp member 171 toward a side surface portion of the support substrate S adjacent to the glue G which is the bonding portion of the substrate to be processed W and the support substrate S in the side surface of the superimposed substrate T. Accordingly, with the peeling apparatus 5 according to the first exemplary embodiment, the efficiency in peeling processing may be enhanced. Further, the probability of damaging the sharp member 171 by being contacted with the substrate to be processed W may be reduced.

In addition, in the peeling apparatus 5 according to the first exemplary embodiment, the second holding unit 150 includes the first suction and moving unit 190 and the second suction and moving unit 200. The first suction and moving unit 190 sucks a circumferential edge portion of the support substrate S corresponding to the peeling initiation area M and moves the circumferential edge portion in a direction of separating the circumferential edge portion from the surface of the substrate to be processed W. Further, the second suction and moving unit 200 sucks the central portion of the support substrate S and moves the central portion in the direction of separating the central portion from the surface of the substrate to be processed W. Accordingly, with the peeling apparatus 5 according to the first exemplary embodiment, the superimposed substrate T may be separated into the support substrate S and the substrate to be processed W without applying a large load to the support substrate S. In addition, the superimposed substrate T may be peeled off within a short time.

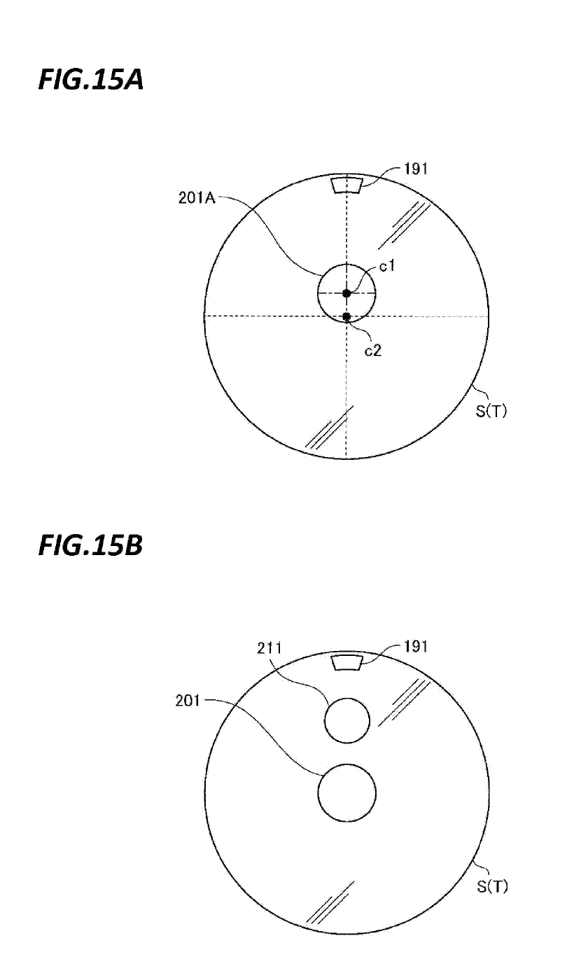

The configuration of the second holding unit is not limited to the configuration illustrated in the first exemplary embodiment. Accordingly, hereinbelow, a modified example of the second holding unit will be described with reference to FIGS. 15A and 15B. FIGS. 15A and 15B are schematic plan views illustrating modified examples of the second holding unit.

In the first exemplary embodiment, an example in which the second suction and moving unit sucks and holds the central portion of the support substrate S is illustrated. However, the region sucked and held by the second suction and moving unit may be a region which is slightly closer to the suction pad of the first suction and moving unit as compared to the central portion of the support substrate S.

For example, as illustrated in FIG. 15A, the center c1 of the suction pad 201A may be positioned closer to the suction pad 191 as compared to the center c2 of the support substrate S and configured to suck a region where the center c2 of the support substrate S is included.

When a region slightly closer to the suction pad 191 as compared to the central portion of the support substrate S, that is, a region closer to the peeling progressing direction is sucked and pulled up, the central portion that requires a large tensile force may be efficiently peeled off.

In addition, the second holding unit may be configured to include a plurality of second suction and moving units. For example, as illustrated in FIG. 15B, the second holding unit further includes a suction pad 211. The suction pad 211 is arranged between the suction pad 191 and the suction pad 201 and connected to the moving mechanism through the strut member like the suction pads 191, 201.

When the plurality of second suction and moving units are provided, the superimposed substrate T may be peeled off within a shorter time as compared with a case where one second suction and moving unit is provided.

The suction area of the suction pad 211 is larger than that of the suction pad 191 provided at the base end side in the peeling progressing direction and smaller than the suction pad 201 provided at the front end side in the peeling progressing direction. That is, the suction pads 191, 201, 211 are formed such that the suction areas thereof are increased toward the front end side in the peeling progressing direction.

### Second Exemplary Embodiment

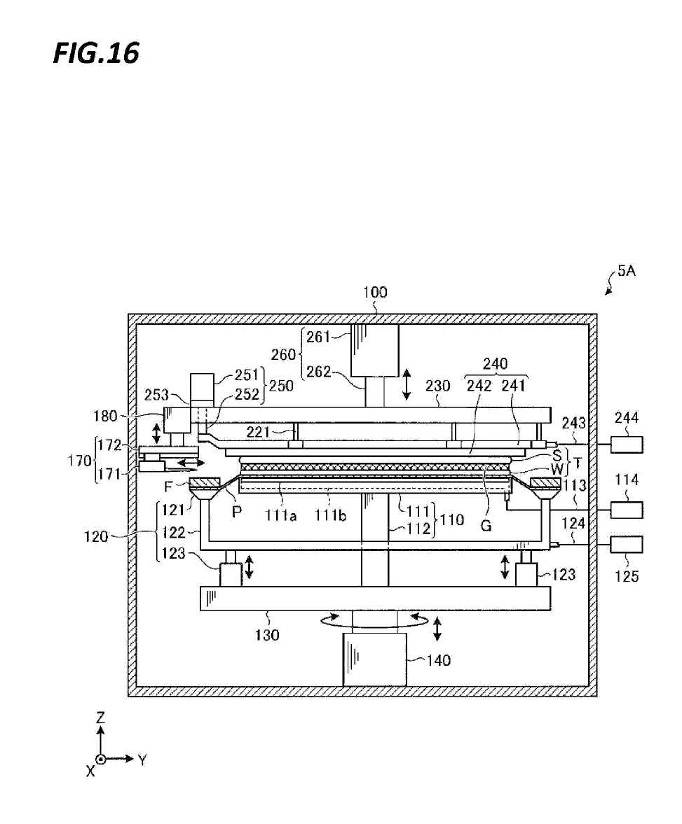

In the second exemplary embodiment, another configuration of the peeling apparatus will be described. FIG. 16 is a schematic side view illustrating a configuration of the peeling apparatus according to the second exemplary embodiment. In the following descriptions, the constituent elements which are the same as those described above will be assigned the same symbols and overlapping descriptions will be omitted.

As illustrated in FIG. 16, the peeling apparatus 5A includes an upper base unit 230, a second holding unit 240, a local moving unit 250, and a moving mechanism 260, instead of the fixing member 101, the strut 102, the second holding unit 150, and the upper base unit 160 provided in the peeling apparatus 5 according to the first exemplary embodiment.

The second holding unit 240 is supported from the upper side by the upper base unit 230. The upper base unit 230 is supported by the moving mechanism 260. When the moving mechanism 260 moves the upper base unit 230 in the vertical direction, the second holding unit 240 is lifted in the vertical direction.

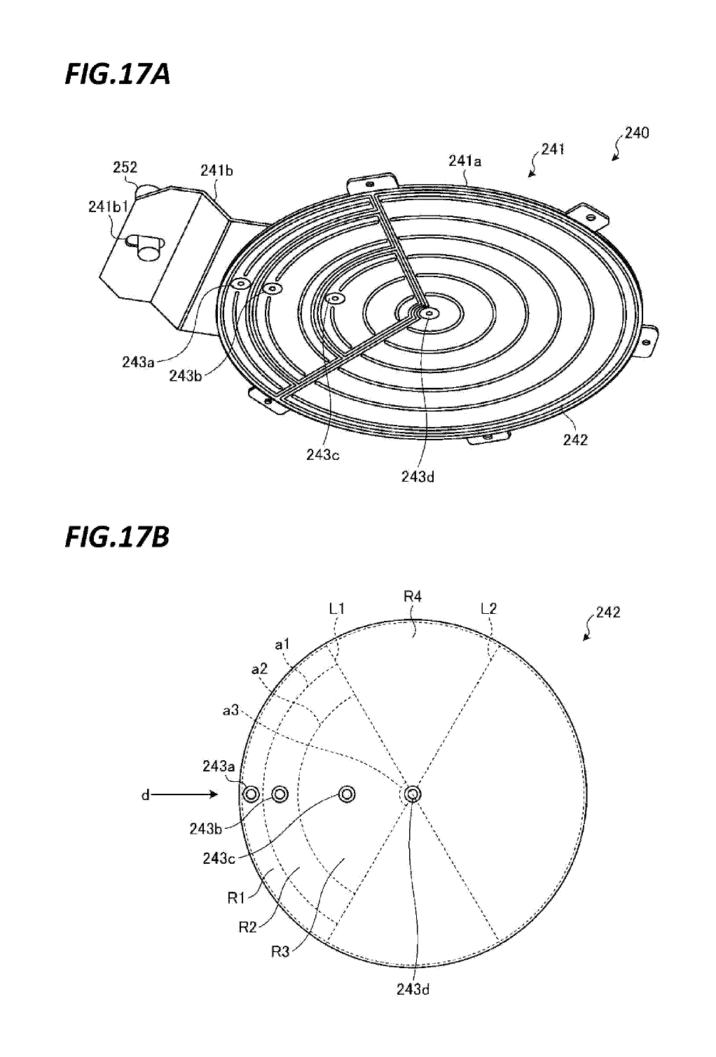

The second holding unit 240 is formed of a flexible member so that the shape of the second holding unit 240 may be flexibly changed when the second holding unit 240 is pulled up by the local moving unit 250 to be described later. The detailed configuration of the second holding unit 240 will be described with reference to FIGS. 17A and 17B. FIG. 17A is a schematic perspective view illustrating the configuration of the second holding unit 240 according to the second exemplary embodiment and FIG. 17B is a schematic plan view illustrating the configuration of the suction pad.

As illustrated in FIG. 17A, the second holding unit 240 includes a body 241 of a thin plate shape 241 and a suction pad 242 adhered to the body 241. The body 241 is formed of an elastic member such as, for example, a leaf spring and the suction pad 242 is formed of a resin member.

The body 241 has a disc-shaped portion 241a having a diameter which is substantially the same as that of a superimposed substrate T, and the suction pad 242 is adhered to the bottom surface of the disc-shaped portion 241a.

A tensile portion 241b is provided at an outer circumference of the disc-shaped portion 241a. At the front end portion of the tensile portion 241b, an attachment portion 241b1 is formed so as to attach a cylinder 252 of the local moving unit 250.

The suction pad 242 is a disc-shaped resin member which is formed with a suction region of the superimposed substrate T. As illustrated in FIG. 17B, the suction region of the suction pad 242 is divided into a plurality of individual regions R1, R2, R3, R4 by a plurality of straight lines L1, L2 extending radially from the center and a plurality of circular arcs a1, a2, a3.

The individual regions R1, R2, R3, R4 are formed with intake ports 243a, 243b, 243c, 243d), respectively. Each of the intake ports 243a, 234b, 234c, 243d is connected to an intake apparatus 244 such as, for example, a vacuum pump, through an intake pipe 243 as illustrated in FIG. 16. The second holding unit 240 sucks the support substrate that forms the superimposed substrate T from each of the intake ports 243a, 243b, 243c, 243d by the air-intake of the intake apparatus 244 so that the support substrate S is sucked and held at each of the individual regions R1, R2, R3, R4.

As described above, when the suction region of the suction pad 242 is divided into the plurality of individual regions R1, R2, R3, R4 and each of the individual regions R1, R2, R3, R4 sucks and holds the support substrate S, for example, even if air leakage or the like occurs at some of the individual regions, the support substrate S may be properly held by other individual regions.

The individual regions R1, R2, R3, R4 are formed such that the individual regions provided at the front end side in the peeling progressing direction are larger than the individual regions provided at the base end side in the peeling progressing direction. For example, the individual regions R1, R2, R3 are arranged in the order of the individual region R1, the individual region R2, and the individual region R3 along the peeling progressing direction in which the individual region R2 is larger than the individual region R1 and the individual region R3 is larger than the individual region R2.

As the suction region is reduced, the suction force at the suction region is increased. Thus, with the arrangement as described above, the suction force of the individual region R1 arranged at the base end side in the peeling progressing direction may be set to high as compared with other individual regions R2, R3, R4. In addition, the region at the base end side in the peeling progressing direction is a region where the largest force is required when the substrate to be processed W and the support substrate S are peeled off. Accordingly, when the suction force of the region is increased, it may be assured that the substrate to be processed W and the support substrate S are securely peeled off.

In addition, when the intake ports 243a, 243b, 243c, 243d of the individual regions R1, R2, R3, R4 are formed side by side along the peeling progressing direction, the support substrate S may be more securely held during the peeling operation.

Returning back to FIG. 16, the descriptions on the configuration of the peeling apparatus 5A will be continued. Above the second holding unit 240, the upper base unit 230 is disposed to be opposite to the second holding unit 240 with a clearance being interposed therebetween. The bottom surface of the upper base unit 230 is provided with a plurality of support members 221 which protrude toward the second holding unit 240. When the support members 221 and the second holding unit 240 are fixed to each other, the second holding unit 240 is in the state where it is supported by the upper base unit 230.

The local moving unit 250 moves a part of the circumferential edge of the second holding unit 240 in a direction of separating the part from the first holding unit 110. Specifically, the local moving unit 250 includes a body 251 fixed to the upper base unit 230 and a cylinder 252 having a base end portion fixed to the body 251 and configured to be lifted along the vertical direction by the body 251. The front end of the cylinder 252 is fixed to the attachment portion 241b1 (see, e.g., FIG. 17A) of the tensile portion 241b provided in the body 241 of the second holding unit 240.

The local moving unit 250 moves the tensile portion 241b fixed to the cylinder 252 by moving the cylinder vertically upwardly using the body 251. As a result, a part of the circumferential edge of the support substrate S held by the second holding unit 240 is moved vertically upwardly so that the part is peeled from the substrate to be processed W held by the second holding unit 240.

In addition, the local moving unit 250 is provided with a load cell 253 which is configured to detect a load applied to the cylinder 250. The local moving unit 250 may pull up the second holding unit 240 while controlling the vertically upward force applied to the support substrate S based on the detection result by the load cell 253.

A moving mechanism 260 is arranged above the upper base unit 230. The moving mechanism 260 includes a body 261 fixed to the ceiling portion of the processing unit 100 and a drive unit 262 having a base end portion fixed to the body 261 and configured to be lifted along the vertical direction. As for the drive unit 262, for example, a motor or a cylinder may be used. The front end portion of the drive unit 262 is fixed to the upper base unit 230.

The moving mechanism 260 moves the upper base unit 230 fixed to the drive unit 262 along the vertical direction by moving the drive unit 262 vertically upwardly using the body 261. As a result, the second holding unit 240 and the local moving unit 250 supported by the upper base unit 230 are lifted.

The peeling apparatus 5A configured as described above moves down the second holding unit 240 using the moving mechanism 260 after performing steps S201 to 204 illustrated in FIG. 10. As a result, the second holding unit 240 comes into contact with the support substrate S. Then, the peeling apparatus 5A sucks and holds the support substrate S using the second holding unit 240.

Subsequently, the peeling apparatus 5A pulls up a part of the circumferential edge of the second holding unit 240 using the local moving unit 250. Specifically, the local moving unit 250 moves the tensile portion 241b provided in the second holding unit 240 vertically upwardly by the operation of the cylinder 252. As a result, the circumferential edge of the superimposed substrate T is pulled up vertically upwardly so that the support substrate S starts to be peeled off from the substrate to be processed W continuously from the circumferential edge toward the central portion thereof.

Because the second holding unit 240 is formed of a flexible member as described above, when the local moving unit 250 pulls up the tensile portion 241b of the second holding unit 240 vertically upwardly, the second holding unit 240 is flexibly deformed according to the pulling. As a result, the peeling apparatus 5A may be peeled off the support substrate S from the substrate to be processed W without applying a large load to the substrate to be processed W.

In addition, the peeling apparatus 5A moves up the second holding unit 240 using the moving mechanism 260. As a result, the support substrate S is peeled off from the substrate to be processed W. Then, the peeling processing of the peeling apparatus 5A is finished.

As described above, the peeling apparatus 5A according to the second exemplary embodiment includes the second holding unit 240 which is formed of a flexible member. Accordingly, the support substrate S may be peeled off from the substrate to be processed W without applying a large load to the substrate to be processed W.

### Third Exemplary Embodiment

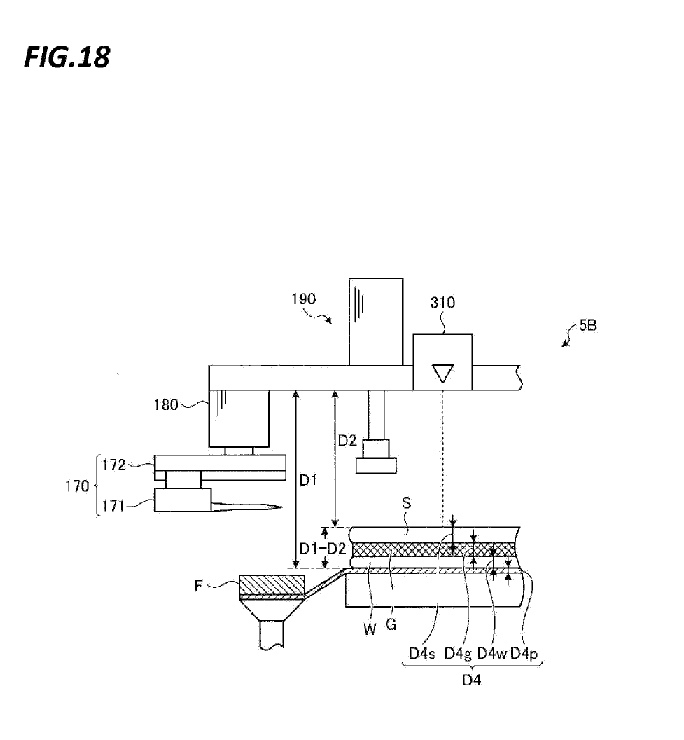

The peeling apparatus may further include a measurement unit configured to measure the height position of the sharp member 171. Hereinafter, an example corresponding to this case will be described. FIG. 18 is a view illustrating an operation example of a measurement processing by a measurement unit.

As illustrated in FIG. 18, the peeling apparatus 5B according to a third exemplary embodiment includes a measurement unit 310 in addition to respective constituent elements provided in the peeling apparatus 5 according to the first exemplary embodiment.

The measurement unit 310 is, for example, a laser displacement gauge and is installed, for example, on the upper base unit 230. The measurement unit 310 measures a distance from a predetermined measurement reference position to a holding surface of the first holding unit 110 or a distance from the measurement reference position to an object interposed between the measurement reference position and the holding surface.

A measurement result by the measurement unit 310 is transmitted to a control device 60 (see, e.g., FIG. 1). The control device 60 stores information related to a thickness of a superimposed substrate T which has been acquired in advance by an external device (hereinafter, referred to as “advance thickness information” to a storage unit which is not illustrated. The advance thickness information includes a thickness of a superimposed substrate T, a thickness of a substrate to be processed W, a thickness of a support substrate S, a thickness of a glue G, and a thickness of a dicing tape P.

The control device 60 determines the height position of the sharp member 171 so that the sharp member 171 comes into contact with a side surface portion of the support substrate S adjacent to the glue G, based on the measurement result acquired from the measurement unit 310 and the advance thickness information stored in the storage unit. Further, the control device 60 controls the positioning unit 180 to move the peeling inducing unit 170 such that the front end of the sharp member 171 is positioned at a determined height position.

Here, a position adjustment processing of the peeling inducing unit 170 will be described in detail. First, the peeling apparatus 5B measures a distance up to the holding surface, D1, of the first holding unit 110 using the measurement unit 310. At this time, a superimposed substrate T is not yet carried into the peeling apparatus 5B.

In addition, the thickness of the superimposed substrate T, D4, the thickness of the substrate to be processed W, D4w, the thickness of the glue G, D4g, the thickness of the support substrate S, D4s, and the thickness of the dicing tape P, D4p, as illustrated in FIG. 18 are stored in the storage unit of the control device 60 as advance thickness information.

Subsequently, the peeling apparatus 5B sucks and holds the superimposed substrate T and the dicing frame F using the first holding unit 110 and the frame holding unit 120 and then, measures the distance up to the top surface of the superimposed substrate T, D2, sucked and held by the first holding unit 110, that is, the distance up to the non-bonding surface Sn of the support substrate S, D2. The measurement result is transmitted to the control device 60. The control device 60 determines whether the difference between the thickness of the superimposed substrate T, D1−D2, calculated from the measurement result of the measurement unit 310 and the thickness of the superimposed substrate, D4, included in the advance thickness information is within a predetermined range.

Here, when the margin of error between the thickness of the superimposed substrate T, D1−D2, calculated from the measurement result of the measurement unit 310 and the thickness D4 represented by the advance thickness information exceeds a predetermined range, there is possibility that a superimposed substrate T which is different from a superimposed substrate T to be carried in originally has been erroneously carried in, for example. In such a case, the sharp member 171 may not be contacted with the side surface portion of the support substrate S adjacent to the glue G and, in some cases, the sharp member 171 may come into with the substrate to be processed W, damaging the substrate to be processed W.

For this reason, when the margin of error between the thickness of the superimposed substrate T calculated using the measurement result of the measurement unit 310 and the thickness of the superimposed substrate T included in the advance thickness information exceeds the predetermined range, the peeling apparatus 5B stops the subsequent processing.

Meanwhile, when the margin of error with reference to the advance thickness information is within the predetermined range, the control device 60 calculates the range of the side surface portion of the support substrate S adjacent to the glue G, that is, the height range from the position of one half of the thickness of the support substrate S to the bonding surface Sj based on the advance thickness information. Specifically, the side surface portion of the support substrate S adjacent to the glue G is in the range of D2+D4s/2 to D2+D4s. Then, the control device 60 determines the height position of the sharp member 171 within the height range.

When the cutting position of the peeling inducing unit 170 is determined by the control device 60, the peeling apparatus 5B moves the peeling inducing unit 170 using the positioning unit 180 based on the control of the control device 60, thereby adjusting the height position of the sharp member 171.

As described above, the peeling apparatus 5B according to the third exemplary embodiment includes the measurement unit 310 and the positioning unit 180. The measurement unit 310 measures a distance from a predetermined measurement reference position to the holding surface of the first holding unit 110 or a distance from the measurement reference position to an object interposed between the measurement reference position and the holding surface of the first holding unit 110. The positioning unit 180 adjusts the contact position of the sharp member 171 in relation to the support substrate S based on the measurement result of the measurement unit 310 and the information relating to the thickness of the superimposed substrate T acquired in advance. As a result, the sharp member 171 may be precisely contacted with a side surface portion of the support substrate S adjacent to the glue G.

In addition, the peeling apparatus 5B may be configured to diagnose the presence of damage of the sharp member 171 using the measurement unit 310. In such a case, the peeling apparatus 5B measures a distance up to the top surface of the sharp member 171 using the measurement unit 310 while moving the sharp member 171 horizontally using the moving mechanism 172 and transmits the measurement result to the control device 60. For example, when the change rate of the distance up to the top surface of the sharp member 171 exceeds a predetermined range, or the margin of error as compared with a reference distance measured in advance using a sharp member 171 of a new product exceeds a predetermined range, the control device 60 determines that the sharp member 171 is damaged.

When it is determined that the sharp member 171 is damaged, the peeling apparatus 5B stops the subsequent processing. As a result, occurrence of particles caused by the damage of the support substrate S or the nicked edge when the peeling inducing processing is performed using a damaged sharp member 171 may be prevented in advance.

Here, it has been exemplified that the measurement unit 301 is provided in the peeling apparatus according to the first exemplary embodiment, measurement unit 310. However, the measurement unit 301 may be provided in the peeling apparatus 5A according to the second exemplary embodiment.

### Other Exemplary Embodiments

In each of the exemplary embodiments described above, it has been exemplified that the superimposed substrate to be peeled off is a superimposed substrate T in which a substrate to be processed W and a support substrate S is bonded to each other by a glue G. However, the superimposed substrate to be peeled off by the peeling apparatus is not limited to such a superimposed substrate T. For example, in the peeling apparatus of each of the exemplary embodiments as described above, a superimposed substrate in which a donor substrate formed with an insulation film and a substrate to be processed are bonded to each other so as to produce an SOI substrate may be an object to be peeled off.

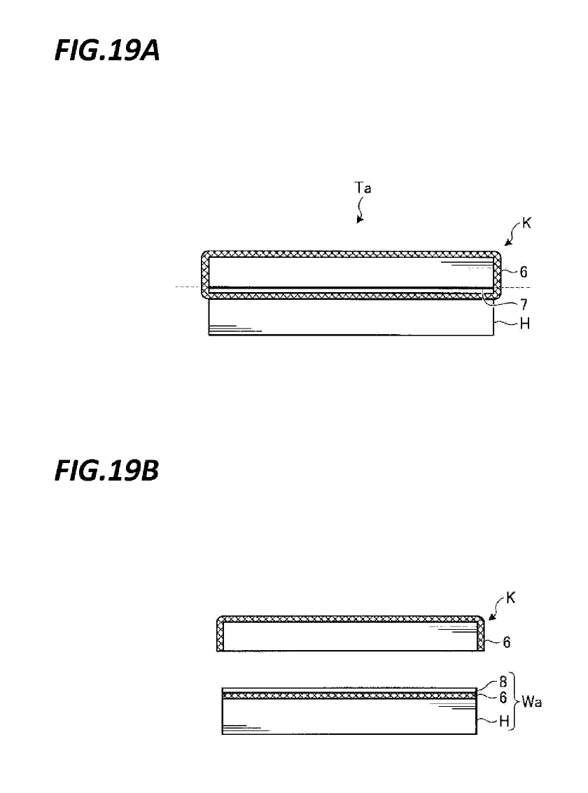

Here, a method of manufacturing an SOI substrate will be described with reference to FIGS. 19A and 19B. FIGS. 19A and 19B are schematic views illustrating a process of manufacturing an SOI substrate. As illustrated in FIG. 19A, a superimposed substrate Ta for forming an SOI substrate is formed by bonding a donor substrate K and a handle substrate H.

The donor substrate K has an insulation film 6 formed on a surface thereof and a hydrogen ion implantation layer 7 formed in a predetermined depth adjacent to the surface at the side bonded to the handle substrate H. As for the handle substrate H, for example, a silicon wafer, a glass substrate, or a sapphire substrate may be used.

In the peeling apparatus of each of the exemplary embodiments as described above, for example, when the circumferential edge of the superimposed substrate Ta is pulled up in a state where the donor substrate K is held by the first holding unit and the handle substrate H is held by the second holding unit, a mechanical impact is applied to the hydrogen ion implantation layer 7 formed in the donor substrate K. Therefore, as illustrated in FIG. 19B, silicon-silicon bonds within the hydrogen ion implantation layer 7 are cut so that the silicon layer 8 is peeled off from the donor substrate K. As a result, the insulation film 6 and the silicon layer 8 are image-transferred to the top surface of the handle substrate H so that an SOI substrate Wa is formed. In addition, although it is desirable that the donor substrate K is held by the first holding unit and the handle substrate H is held by the second holding unit, the handle substrate H may be held by the first holding unit and the donor substrate K may be held by the second holding unit.

In addition, in the above-described exemplary embodiments, it has been exemplified that a substrate to be processed W and a support substrate S are bonded using a glue G. However, the bonding surfaces Wj, Sj may be divided into a plurality of regions which may be coated with glues of different adhesive forces, respectively.

In addition, in the above-described exemplary embodiments, it has been exemplified that the second holding unit holds the superimposed substrate T from the upper side. However, the second holding unit may hold the superimposed substrate T from the lower side.

Further, in the above-described exemplary embodiments, it has been exemplified that a superimposed substrate T is maintained by a dicing frame F. However, the superimposed substrate T does not have to be maintained by the dicing frame F.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A peeling apparatus comprising:
a first holding unit configured to hold a first substrate of a superimposed substrate in which the first substrate and a second substrate are bonded;
a second holding unit configured to hold the second substrate of the superimposed substrate and move the second substrate in a direction of separating the second substrate from a surface of the first substrate; and
a peeling inducing unit configured to form an area where the second substrate starts to be peeled off from the first substrate on a side surface of the superimposed substrate,
wherein the peeling inducing unit includes:
a sharp member; and
a moving mechanism configured to move the sharp member toward a side surface portion of the second substrate adjacent to a bonding portion of the first substrate and the second substrate in the side surface of the superimposed substrate.

2. The peeling apparatus of claim 1, wherein the moving mechanism moves the sharp member further forward after the sharp member comes into contact with the side surface portion of the second substrate adjacent to the bonding portion.

3. The peeling apparatus of claim 2, further comprising:
a first holding unit moving mechanism configured to move the first holding unit in a direction of separating the first substrate from the second substrate,
wherein the moving mechanism moves the sharp member further forward while the first holding unit moving mechanism moves the first holding unit.

4. The peeling apparatus of claim 1, wherein the sharp member is formed of a hard metal.

5. The peeling apparatus of claim 1, wherein the second holding unit includes:
a first suction and moving unit configured to suck a circumferential edge of the second substrate corresponding to the area and move the circumferential edge in a direction of separating the circumferential edge from a surface of the first substrate; and
a second suction and moving unit configured to suck a region which is closer to a central portion of the second substrate than to the circumferential edge and move the region in a direction of separating the region from the surface of the first substrate.

6. The peeling apparatus of claim 5, wherein the first suction and moving unit has a suction area which is smaller than that of the second suction and moving unit.

7. The peeling apparatus of claim 5, wherein the second suction and moving unit moves the region which is closer to the central portion of the second substrate than to the circumferential edge in the direction of separating the region from the surface of the first after the first suction and moving unit moves the circumferential edge of the second substrate in the direction of separating the circumferential edge from the surface of the first substrate.

8. The peeling apparatus of claim 5, wherein the second suction and moving unit sucks the central portion of the second substrate.

9. The peeling apparatus of claim 5, wherein the first suction and moving unit has a portion corresponding to an outer edge of the second substrate and formed in an arc shape along the outer edge of the second substrate.

10. The peeling apparatus of claim 1, further comprising:
a measurement unit configured to measure a distance from a predetermined measurement reference position to a holding surface of the first holding unit or a distance from the measurement reference position to an object interposed between the measurement reference position and the holding surface; and
a positioning unit configured to adjust a contact position of the sharp member in relation to the second substrate based on a measurement result of the measurement unit and information relating to a thickness of the superimposed substrate and acquired in advance.

11. The peeling apparatus of claim 1, further comprising:
a rotation mechanism configured to rotate the first holding unit.

12. A peeling system comprising:
a carry-in/out station configured to dispose a superimposed substrate in which a first substrate and a second substrate are bonded;
a substrate conveyance apparatus configured to convey the superimposed substrate disposed in the carry-in/out station; and
a peeling station configured to separate the superimposed substrate conveyed by the substrate conveyance apparatus into the first substrate and the second substrate,
wherein the peeling apparatus includes:
a first holding unit configured to hold a first substrate of the superimposed substrate;
a second holding unit configured to hold the second substrate of the superimposed substrate and move the second substrate in a direction of separating the second substrate from a surface of the first substrate; and
a peeling inducing unit configured to form an area where the second substrate starts to be peeled off from the first substrate on a side surface of the superimposed substrate,
wherein the peeling inducing unit includes:
a sharp member; and
a moving mechanism configured to move the sharp member toward a side surface portion of the second substrate adjacent to a bonding portion of the first substrate and the second substrate in the side surface of the superimposed substrate.

13. A peeling method comprising:
holding, by a first holding unit, a first substrate of a superimposed substrate in which the first substrate and a second substrate are bonded, the first holding unit being configured to hold the first substrate;
holding, by a second holding unit, the second substrate of the superimposed substrate and moving the second substrate in a direction of separating the second substrate from a surface of the first substrate, the second holding unit being configured to hold and move the second substrate in the direction of separating the second substrate from the surface of the first substrate; and
forming, by a peeling inducing unit, an area where the second substrate starts to be peeled off from the first substrate on a side surface of the superimposed substrate by causing a sharp member of the peeling inducing unit to come into contact with a side surface portion of the second substrate adjacent to the bonding portion, thereby inducing peeling, the peeling inducing unit including the sharp member and a moving mechanism configured to move the sharp member toward a side surface portion of the second substrate adjacent to a bonding portion of the first substrate and the second substrate in the side surface of the superimposed substrate.

14. The peeling method of claim 13, wherein the inducing of peeling includes moving the sharp member further forward by the moving mechanism after the sharp member comes into contact with the side surface portion of the second substrate adjacent to the bonding portion.

15. The peeling method of claim 14, wherein the inducing of peeling includes moving the sharp member further forward by the moving mechanism while the first holding unit is moved by a first holding unit moving mechanism configured to move the first holding unit in a direction of separating the first substrate from the second substrate.
